(19) United States
(12) Patent Application Publication
(10) Pub. No.: US 2011/0163525 A1
(43) Pub. Date: Jul. 7, 2011

(54) STEERING-FORCE TRANSMITTING APPARATUS FOR VEHICLE

(75) Inventor: Kenichiro Aoki, Aichi-ken (JP)

(73) Assignee: TOYOTA JIDOSHA KABUSHIKI KAISHA, Aichi (JP)

(21) Appl. No.: 13/060,511

(22) PCT Filed: Sep. 14, 2009
(86) PCT No.: PCT/JP2009/066468

§ 371 Date: Feb. 24, 2011

(30) Foreign Application Priority Data
Sep. 30, 2008 (JP) 2008-254733

(51) Int. Cl. B62D 1/16

(52) U.S. Cl. 280/779; 74/496

(57) ABSTRACT

A steering-force transmitting apparatus including: (a) an operating-member- side shaft; (b) a turning-device-side shaft offset from the operating-member- side shaft; and (c) a rotation transmitting mechanism having (c-1) an engaging portion provided in one of the two shafts and (c-2) a guide passage provided in the other of the two shafts such that the guide passage is held in engagement with the engaging portion. The rotation transmitting mechanism is configured to change a rotational phase difference between the two shafts while causing one of the two shafts to be rotated by rotation of the other of the two shafts. An axially end portion of a main body portion of one of the two shafts and an axially end portion of the other of the two shafts overlap with each other in the axial direction.

This application is based on Japanese Patent Application No. 2008-254733 filed on Sep. 30, 2008, the content of which is incorporated hereinto by reference.

### TECHNICAL FIELD

The present invention relates to a steering-force transmitting apparatus for a vehicle, which is configured to transmit a steering force that is applied to a steering operation member of a vehicle, to a wheel turning device of the vehicle.

### BACKGROUND ART

In recent years, there is a development of a steering-force transmitting apparatus for a vehicle having (i) a steering operation member operable by an operator of the vehicle and (ii) a wheel turning device configured to turn a wheel of the vehicle. The steering-force transmitting apparatus includes an operating-member-side shaft that is connected at its axial end portion to the steering operation member, a turning-device-side shaft that is connected at its axial end portion to the wheel turning device, and a rotation transmitting mechanism that is configured to change a rotational phase difference between a rotational phase of the operating-member-side shaft and a rotational phase of the turning-device-side shaft while causing one of the operating-member-side shaft and turning-device-side shaft to be rotated by rotation of the other of the operating-member-side shaft and turning-device-side shaft. JP-H03-227772A and JP-H05-178222A disclose examples of a steering-force transmitting apparatus equipped with the above-described rotation transmitting mechanism.

### DISCLOSURE OF THE INVENTION

### (A) Outline of the Invention

The steering-force transmitting apparatus equipped with the above-described rotation transmitting mechanism, as compared with a steering-force transmitting apparatus not equipped with the rotation transmitting mechanism, is more likely to have a large length as measured in its axial direction. Therefore, the steering-force transmitting apparatus equipped with the rotation transmitting mechanism has difficulty in being installed onto a vehicle, since it requires an installation space having a larger length as measured in a longitudinal direction of the vehicle, as compared with the steering-force transmitting apparatus not equipped with the rotation transmitting mechanism. Thus, the steering-force transmitting apparatus provided with the rotation transmitting mechanism is still in a developing stage with various problems such as the above-described installation difficulty, and there is still room for improvements. That is, it is considered that practicability of the steering-force transmitting apparatus can be increased by various improvements applied to the apparatus. The present invention was made in the light of the background art discussed above, and has an object of the invention to provide a steering-force transmitting apparatus having a high practicability.

This object may be achieved according to the principle of this invention, which provides a steering-force transmitting apparatus including: (a) an operating-member-side shaft rotatable about an axis thereof; (b) a turning-device-side shaft rotatable about an axis thereof which is parallel to the axis of the operating-member-side shaft and which is offset from the axis of the operating-member-side shaft by a predetermined offset distance; and (c) a rotation transmitting mechanism. The rotation transmitting mechanism includes (c-1) an engaging portion which is provided in a first shaft as one of the operating-member-side shaft and the turning-device-side shaft, and which is provided on a first main body portion that is a main body portion of the first shaft, so as to be rotatable together with the first main body. The engaging portion is held in engagement with an axial end portion of a second shaft as the other of the operating-member-side shaft and the turning-device-side shaft, and is located in a non-central position that is distant from the axis of the first shaft in a radial direction of the first shaft by a distance larger than the predetermined offset distance. The rotation transmitting mechanism further includes (c-2) a guide passage which is provided in the axial end portion of the second shaft and which is held in engagement with the engaging portion. The guide passage extends in a radial direction of the second shaft so as to allow displacement of the engaging portion in the radial direction of the second shaft. The rotation transmitting mechanism is configured to change a rotational phase difference between a rotational phase of the first shaft and a rotational phase of the second shaft, while causing one of the first and second shafts to be rotated by rotation of the other of the first and second shafts. A second-shaft side end of the first main body portion is located between a first-shaft side end of the second shaft and another axial end portion of the second shaft in the axial direction.

In the steering-force transmitting apparatus according to the invention, an axially end portion of the main body portion of one of the operating-member-side shaft and turning-device-side shaft and an axially end portion of the other of the operating-member-side shaft and turning-device-side shaft overlap with each other in the above-described axial direction. This arrangement enables the apparatus to have a small length as measured in the axial direction, thereby making it possible to facilitate installation of the apparatus onto the vehicle, namely, to improve installability of the apparatus onto the vehicle. Owing to such a technical advantage, the present invention is effective to improve practicability of the steering-force transmitting apparatus provided with the rotation transmitting mechanism.

### (B) Modes of the Invention

There will be described various modes of the invention (hereinafter referred to as “claimable invention” where appropriate) deemed to contain claimable features for which protection is sought. Each of these modes of the invention is numbered like the appended claims and depends from the other mode or modes, where appropriate, for easier understanding of the technical features disclosed in the present specification. It is to be understood that the claimable invention is not limited to the technical features or any combinations thereof which will be described in each of these modes. That is, the scope of the claimable invention should be interpreted in the light of the following descriptions accompanying the various modes and preferred embodiment of the invention. In a limit in accordance with such an interpretation, a mode of the claimable invention can be constituted by not only any one of these modes but also either a mode provided by any one of these modes and additional component or components incorporated therein and a mode provided by any one of these modes without some of components recited therein. It is noted that mode (1) described below is a mode serving as a base of a steering-force transmitting apparatus as the claimable invention, and the claimable invention can be constituted by combination of features recited in mode (1) with features recited in suitably selected one or ones of the other modes.

(1) A steering-force transmitting apparatus for a vehicle having (i) a steering operation member operable by an operator of the vehicle and (ii) a wheel turning device configured to turn a wheel of the vehicle, the steering-force transmitting apparatus including:

(a) an operating-member-side shaft connected at one of axially opposite end portions thereof to the steering operation member, and rotatable about an axis thereof;

(b) a turning-device-side shaft connected at one of axially opposite end portions thereof to the wheel tuning device, and rotatable about an axis thereof which is parallel to the axis of the operating-member-side shaft and which is offset from the axis of the operating-member-side shaft by a predetermined offset distance; and

(c) a rotation transmitting mechanism including:
(c-1) an engaging portion which is provided in a first shaft as one of the operating-member-side shaft and the turning-device-side shaft, and which is provided on a first main body portion that is a main body portion of the first shaft, so as to be rotatable together with the first main body, the engaging portion being held in engagement with the other of the axially opposite end portions of a second shaft as the other of the operating-member-side shaft and the turning-device-side shaft, the engaging portion being located in a non-central position that is distant from the axis of the first shaft in a radial direction of the first shaft by a distance larger than the predetermined offset distance; and
(c-2) a guide passage which is provided in the other of the axially opposite end portions of the second shaft and which is held in engagement with the engaging portion, the guide passage extending in a radial direction of the second shaft so as to allow displacement of the engaging portion in the radial direction of the second shaft,

wherein the rotation transmitting mechanism is configured to change a rotational phase difference between a rotational phase of the first shaft and a rotational phase of the second shaft, while causing one of the first and second shafts to be rotated by rotation of the other of the first and second shafts.

The present mode (1) is a mode serving as a base of a steering-force transmitting apparatus as the claimable invention, and reciting basic components that are to be included in the steering-force transmitting apparatus. The “rotation transmitting mechanism” recited in this mode (1) is configured to change the rotational phase difference as a difference between the rotational phases of the respective two shafts, namely, to change a difference between an angle of rotation of the operating-member-side shaft and an angle of rotation of the turning-device-side shaft. For example, when the operating-member-side shaft is rotated from a predetermined rotational angle (that establishes a no-difference state in which there is no difference between the rotational phases of the respective two shafts, i.e., the rotational phase difference is zero), the turning-device-side shaft is rotated only by an angle that is smaller than the angle of rotation of the operating-member-side shaft, until the operating-member-side shaft is rotated by 180°. When the operating-member-side shaft has been rotated by 180°, the turning-device-side shaft is rotated also by 180°, so that the difference between the angles of rotations of the two shafts becomes zero. That is, while the operating-member-side shaft is rotated from the predetermined rotational angle to 180° as another predetermined rotational angle, the difference between the angles of rotations of the two shafts is gradually increased from zero in a first-half stage and then gradually reduced to zero in a second-half stage. Thus, a gear ratio between angular speeds of the respective rotated two shafts, i.e., a ratio of a rotational speed of the turning-device-side shaft to a rotational speed of the operating-member-side shaft is increased as the operating-member-side shaft is rotated from the predetermined rotational angle to 180°. Where the predetermined rotational angle corresponds to a rotational angle of the operating-member-side shaft that is established by positioning the steering operation member in its neutral operating position that causes the wheel to be held without turning, a moderate and stable steering performance is obtained in a stage in which an operating angle of the steering operation member is small, and then a highly responsive steering performance is obtained in a stage in which the operating angle of the steering operation member is large. That is, in the vehicle equipped with the “steering-force transmitting apparatus” described in this mode (1), it is possible to provide an operation feeling to the vehicle operator who operates the steering operation member, without provision of a so-called VGRS (Variable Gear Ratio Steering) system, i.e., a system configured to change a ratio of an amount of turning of the wheel to an amount of operation of the steering operation member, depending on an actuator such as an electromagnetic motor.

The “guide passage” described in this mode (1) does not necessarily have to have a particular construction but may have any construction, as long as it is configured to cause the engaging portion to be guided in the radial direction of the second shaft, by rotation of the second shaft. For example, the guide passage may be provided by a groove which is formed in an axial end surface of the second shaft so as to extend in the radial direction of the second shaft, or may be provided by a hole which is formed in an axial end portion of the second shaft so as to extend in the radial direction of the second shaft. It is noted that the above-described one of the axially opposite end portions of the turning-device-side shaft and the wheel turning device may be connected to each other either directly or via a suitable member such as an intermediate shaft and a universal joint, and that the above-described one of the axially opposite end portions of the operating-member-side shaft and the steering operation member may be connected to each other either directly or via a suitably member such as an intermediate shaft and a universal joint.

(2) The steering-force transmitting apparatus according to mode (1), wherein the second shaft has axially opposite ends such that one of the axially opposite ends of the second shaft is a first-shaft side end of the second shaft that is closer to the first shaft than the other of the axially opposite ends of the second shaft, wherein the first main body portion has axially opposite ends such that one of the axially opposite ends of the first main body portion is a second-shaft side end of the first main body portion that is closer to the second shaft than the other of the axially opposite ends of the first main body portion, and wherein the second-shaft side end of the first main body portion is located between the first-shaft side end of the second shaft and the one of the axially opposite end portions of the second shaft in an axial direction that is parallel to the axis of the first shaft and the axis of the second shaft.

The above-described rotation transmitting mechanism is constructed such that the engaging portion is provided in one of the two shafts and is held in engagement with the guide passage that is provided in an axially end portion of the other of the two shafts. Therefore, the steering-force transmitting apparatus equipped with the rotation transmitting mechanism, as compared with a steering-force transmitting apparatus not equipped with the rotation transmitting mechanism, could have a large length as measured in its axial direction. Where the steering-force transmitting apparatus has a large length, the apparatus has difficulty in being installed onto a vehicle, since a space available for the installation of the apparatus in the vehicle is limited.

Further, there is a case where the steering-force transmitting apparatus is equipped with a so-called power steering device, i.e., an assisting device configured to assist the wheel to be turned. It is common that the power steering device is configured to generate an assisting force whose amount is dependent on an amount of twisting deformation of a torsion bar that is included in one of the two shafts which is constituted by at least two parts (that include the torsion bar). The torsion bar is required to have a certain length in view of a required degree of stiffness of the torsion bar, so that it is not desirable to reduce the length of the above-described one of the two shafts in the axial direction. Therefore, in the steering-force transmitting apparatus equipped with the rotation transmitting mechanism, it is desirable to reduce the length of the steering-force transmitting apparatus, without reducing the length of each of the two shafts.

In the light of what is described above, in the steering-force transmitting apparatus according to this mode (2), an axially end portion of the main body portion of one of the two shafts and an axially end portion of the other of the two shafts overlap with each other in the above-described axial direction. More specifically, the second-shaft side end of the first main body portion is located between the first-shaft side end of the second shaft and the above-described one of the axially opposite end portions of the second shaft in the axial direction, so that the axially end portion of the first main body and the axially end portion of the second shaft overlap with each other in the axial direction. This arrangement makes it possible to reduce the entire axial length of the apparatus as measured in the axial direction without reducing the length of each of the two shafts, and accordingly to improve installability of the apparatus onto the vehicle. It is noted that the above-described one of the axially opposite end portions of the second shaft may be referred to as an operating-member-side end portion of the second shaft where the second shaft is provided by the operating-member-side shaft, and that the above-described one of the axially opposite end portions of the second shaft may be referred to as a turning-device-side end portion of the second shaft where the second shaft is provided by the turning-device-side shaft.

(3) The steering-force transmitting apparatus according to mode (1) or (2), wherein the guide passage is defined by a pair of side wall surfaces which extend in the radial direction of the second shaft and which are opposed to each other, and wherein the engaging portion held in engagement with the guide passage is interposed between the side wall surfaces, so as to limit displacement of the engaging portion in a circumferential direction of the second shaft.

In the steering-force transmitting apparatus according to this mode (3) in which the guide passage is constructed as specified in this mode (3), the engaging portion can be guided in the radial direction of the second shaft as a result of rotation of the second shaft.

(4) The steering-force transmitting apparatus according to any one of modes (1) to (3), wherein the first main body portion is a hollow portion having a space extending along the axis of the first shaft, and has axially opposite end portions such that one of the axially opposite end portions of the first main body portion is a second-shaft side end portion of the first main body portion that is closer to the second shaft than the other of the axially opposite end portions of the first main body portion, wherein the first shaft has a torsion bar disposed in the space, and having axially opposite end portions such that one of the axially opposite end portions of the torsion bar is closer to the second shaft than the other of the axially opposite end portions of the torsion bar, and wherein the one of the axially opposite end portions of the torsion bar is unrotatably held by the second-shaft side end portion of the first main body such that the torsion bar is twistable by a rotational force that is applied to the first shaft, the steering-force transmitting apparatus further including: an assisting device configured to generate, based on an amount of twisting deformation of the torsion bar, an assisting force that assists the wheel to be turned.

In the steering-force transmitting apparatus according to this mode (4), there is provided the assisting device such as a so-called power steering device. In a steering-force transmitting apparatus provided with a power steering device, there is a case where a torsion bar is coaxially provided in one of the operating-member-side shaft and turning-device-side shaft, and the power steering device generates a wheel-turning assisting force such that an amount of the generated assisting force is dependent on an amount of twisting deformation of the torsion bar. The torsion bar is required to have a certain length in view of a required degree of stiffness of the torsion bar, so that it is not desirable to reduce the length of the above-described one of the two shafts (in which the torsion bar is coaxially provided). It is therefore preferable that the two shafts are positioned relative to each other such that the two shafts at least partially overlap with each other in the axial direction, so as to make it possible to reduce the entire axial length of the apparatus without reducing the length of each of the shafts. This technical advantage is enjoyable particularly in the apparatus according to this mode (4).

(5) The steering-force transmitting apparatus according to mode (4), _{w}herein the first shaft is the turning-device-side shaft while the second shaft is the operating-member-side shaft.

It is not desirable that the wheel-turning assisting force generated by the assisting device is applied to the rotation transmitting mechanism, in view of load applied to the engaging portion or other components of the rotation transmitting mechanism in case of application of the generated assisting force to the rotation transmitting mechanism, because the generated assisting force is considerably large. In the steering-force transmitting apparatus according to this mode (5) in which the wheel-turning assisting force is not applied to the rotation transmitting mechanism, the load applied to the rotation transmitting mechanism can be reduced whereby durability of the rotation transmitting mechanism can be improved.

(6) The steering-force transmitting apparatus according to any one of modes (1) to (5), wherein the second shaft includes: a second main body portion which is a main body portion of the second shaft and which has axially opposite end portions such that one of the axially opposite end portions of the second main body portion is a first-shaft side end portion of the second main body portion that is closer to the first shaft than the other of the axially opposite end portions of the second main body portion; and a radially projecting portion which is provided in the first-shaft side end portion of the second main body portion, and which projects outwardly from the second main body portion in the radial direction of the second shaft, wherein the second shaft has axially opposite ends such that one of the axially opposite ends of the second shaft is a first-shaft side end of the second shaft that is closer to the first shaft than the other of the axially opposite ends of the second shaft, wherein the radially projecting portion has an axial end surface that constitutes a surface of the first-shaft side end of the second shaft, and wherein the guide passage is provided in the radially projecting portion.

In the apparatus according to this mode (6) in which the second shaft is constructed as specified in this mode (6), the “radially projecting portion” described in this mode (6) may be provided in a part or parts of an outer circumferential surface of the second-shaft side end portion of the second main body portion, without extending throughout 360° in a circumferential direction of the second shaft, or may be provided in an entirety of the outer circumferential surface of the second-shaft side end portion of the second main body portion, so as to extend throughout 360° in the circumferential direction.

(7) The steering-force transmitting apparatus according to mode (6), further including a tubular-shaped housing that is fixed to a part of a body of the vehicle, wherein the second shaft is rotatably supported, at the second main body portion, by the housing.

In the apparatus according to this mode (7), the second shaft is supported, at its main body portion (i.e., at the second main body portion), by the housing via components such as bearings. Therefore, even where the radially projection portion is a disk-shaped portion, the second shaft does not have to be supported at the radially projecting portion, so that components such as bearing do not have to be fitted on an outer periphery of the radially projecting portion that has an outside diameter larger than an outside diameter of the main body portion. Therefore, the apparatus according to this mode (7) can be made compact in size as measured in its radial direction. It is noted that the apparatus according to this mode (7) is advantageous for an arrangement in which the apparatus is constituted as a steering column since the second shaft is rotatably supported by the housing.

The “housing” described in this mode (7) may be adapted to rotatably support not only the second shaft but also the first shaft. Further, the housing may constitute either a part of the wheel turning device or a part of the steering column.

(8) The steering-force transmitting apparatus according to mode (6) or (7), wherein the second shaft has a recess that opens in the axial end surface of the radially projecting portion, wherein the first main body portion has axially opposite end portions such that one of the axially opposite end portions of the first main body portion is a second-shaft side end portion of the first main body that is closer to the second shaft than the other of the axially opposite end portions of the first main body portion, and wherein the second-shaft side end portion of the first main body portion is accommodated in the recess of the second shaft.

In the apparatus according to this mode (8), the second shaft has the cavity or recess that opens in the axial end surface of the radially projecting portion, and the first main body portion is accommodated, at its second-shaft side end portion, in the recess. This arrangement makes it possible to reduce the entire axial length of the steering-force transmitting apparatus by an amount corresponding to a length of the second-shaft side end portion (which is accommodated in the recess) of the first main body portion as measured in the axial direction. Further, this arrangement makes it possible to easily establish an arrangement in which the second-shaft side end of the first main body portion is located between the first-shaft side end of the second shaft and the above-described one of the axially opposite end portions of the second shaft in the axial direction.

(9) The steering-force transmitting apparatus according to mode (8), wherein the guide passage has a proximal end as one of radially opposite ends thereof which is closer to the axis of the second shaft than the other of the radially opposite ends, wherein the recess has a connected portion at which the recess is connected to the proximal end of the guide passage, wherein the first shaft includes a radially protruding portion protruding outwardly from the second-shaft side end portion of the first main body portion, in a radial direction of the first shaft, such that the radially protruding portion is introduced into the guide passage via the connected portion of the recess, and wherein the radially protruding portion has a radially distal end portion that serves as the engaging portion.

In the apparatus according to this mode (9), the radially protruding portion protrudes outwardly from the second-shaft side end portion of the first main body portion which is accommodated in the recess of the second shaft, and is introduced into the guide passage via the connected portion (at which the recess is connected to the proximal end of the guide passage), so that the radially distal end portion of the radially protruding portion serves as the engaging portion. This arrangement makes it possible to simplify construction of the engaging portion and construction of structure holding the engaging portion.

In the steering-force transmitting apparatus disclosed in each of the above-identified Japanese Unexamined Patent Application Publications (JP-H03-227772A and JP-H05-178222A), the first shaft includes, in addition to its main body portion, a radially projecting portion which is integral with the main body portion and which projects radially outwardly from the main body portion. The radially projecting portion holds an engaging portion that protrudes in a direction which is toward the second shaft and which is parallel to the axial direction. The engaging portion is introduced in a guide passage formed in the second shaft, and is engaged in the guide passage. However, the radially projecting portion holding the engaging portion is not introduced in to the guide passage. On the other hand, in the apparatus according to this mode (9), not only the radially distal end portion (serving as the engaging portion) of the radially protruding portion but also a radially intermediate portion (serving as a holing portion holding the radially distal end portion) of the radially protruding portion is accommodated in the guide passage. It is noted that the radially intermediate portion of the radially protruding portion is located between the radially distal end portion of the radially protruding portion and a radially proximal end portion of the radially protruding portion. Therefore, the entire axial length of the apparatus according to this mode (9) can be made smaller than the apparatus provided with the first shaft that has the radially projecting portion, by an amount corresponding to an axial length of the radially projecting portion.

(10) The steering-force transmitting apparatus according to mode (9), wherein the guide passage is defined by a pair of side wall surfaces which extend in the radial direction of the second shaft and which are opposed to each other, wherein the engaging portion held in engagement with the guide passage is interposed between the side wall surfaces, so as to limit displacement of the engaging portion in a circumferential direction of the second shaft, wherein the radially protruding portion has a small-width portion that is located between the radially distal end portion and a radially proximal end of the radially protruding portion, and wherein a width of the small-width portion is made smaller than a width of the radially distal end portion, as measured in a circumferential direction of the first shaft, for thereby avoiding interference of the radially protruding portion with a radially inner end portion of each of the side wall surfaces, in spite of change of the rotational phase difference, the change causing change of an angle between the radial direction of the first shaft and the radial direction of the second shaft.

If a width of a portion of the radially protruding portion that is located between the radially distal end portion and the radially proximal end of the radially protruding portion is substantially the same as a distance between the pair of side wall surfaces, as measured in the circumferential direction, it is not possible to allow the radial direction of the first shaft (in which the radially protruding portion protrudes) and the radial direction of the second shaft (in which the side wall surfaces extend) to be deviated from each other, so that rotation of each one of the two shafts relative to the other is impeded. On the other hand, in the apparatus according to this mode (10), it is possible to allow the radial direction of the first shaft and the radial direction of the second shaft to be deviated from each other, thereby enabling each one of the two shafts to be rotatable relative to the other.

(11) The steering-force transmitting apparatus according to mode (10), wherein the rotation transmitting mechanism is configured to equalize the rotational phase of the first shaft and the rotational phase of the second shaft to each other, when the rotational phase of the first shaft is either one of two predetermined values, wherein the radially inner end portion of each of the side wall surfaces is closer to the axis of the first shaft than to an outer periphery of the first main body portion when the rotational phase of the first shaft is one of the two predetermined values, and wherein the first main body portion has a contiguous portion which is contiguous to the radially proximal end of the radially protruding portion and which is provided by at least one recessed portion of an outer circumferential surface of the first main body portion, the at least one recessed portion being recessed for avoiding interference of the first main body portion with the radially inner end portion of each of the side wall surfaces when the rotational phase of the first shaft is the one of the two predetermined values.

The steering-force transmitting apparatus could be made compact in size as measured in its radial direction, even by simply reducing a projecting amount by which the radially projecting portion of the second shaft projects in the radial direction of the second shaft. However, the reduction of the projecting amount of the radially projecting portion would cause the radially distal end portion of the radially protruding portion of the first shaft to protrude outwardly of the radially projecting portion. Therefore, for enabling the radially distal end portion of the radially protruding portion to be moved in the guide passage over a sufficient distance, it is necessary to reduce a protruding amount by which the radially protruding portion of the first shaft protrudes and also to reduce a distance between the radially proximal end of the radially protruding portion and the radially inner end portion of each of the side wall surfaces. Where the radially proximal end of the radially protruding portion and the radially inner end portion of each of the side wall surfaces are close to each other, there is a risk of contact of the contiguous portion of the first main body portion (which is contiguous to the radially proximal end of the radially protruding portion) with the radially inner end portion of each of the side wall surfaces, during rotation of each one of the shafts relative to other. In the apparatus according to this mode (11), it is possible to assure rotation of each one of the shafts relative to the other even in case of reduction of the projecting amount of the radially projecting portion of the second shaft. That is, the apparatus can be made compact in size as measured in its radial direction.

(12) The steering-force transmitting apparatus according to any one of modes (8) to (11), wherein the guide passage is defined by a pair of side wall surfaces which extend in the radial direction of the second shaft and which are opposed to each other, wherein the engaging portion, which is held in engagement with the guide passage, is interposed between the side wall surfaces, so as to limit displacement of the engaging portion in a circumferential direction of the second shaft, wherein the engaging portion, which is interposed between the side wall surfaces and which is provided by the radially distal end portion of the radially protruding portion, is held in contact at contact surfaces thereof with the side wall surfaces, and wherein the contact surfaces of the engaging portion cooperate with each other to define a cylindrical surface, for thereby avoiding separation of each of the contact surfaces from a corresponding one of the side wall surfaces, in spite of change of the rotational phase difference, the change causing change of an angle between the radial direction of the first shaft and the radial direction of the second shaft.

For assuring smooth transmission of rotation from each one of the two shafts to the other, the radially distal end portion of the radially protruding portion is constantly held in contact with both of the side wall surfaces that cooperate with each other to define the guide passage. That is, it is preferable that there is no play between the radially distal end portion of the radially protruding portion and each of the side wall surfaces. In the apparatus according to this mode (12), it is possible to eliminate play between the radially distal end portion of the radially protruding portion and each of the side wall surfaces, irrespective of the rotational angle of each of the shafts, thereby making it possible to assure smooth transmission of rotation from each one of the shafts to the other.

(13) The steering-force transmitting apparatus according to any one of modes (9) to (12), wherein the first shaft is the turning-device-side shaft while the second shaft is the operating-member-side shaft, wherein the first main body portion has axially opposite ends such that one of the axially opposite ends of the first main body portion is a second-shaft side end of the first main body portion that is closer to the second shaft than the other of the axially opposite ends of the first main body portion, and wherein the radially protruding portion, which protrudes from the second-shaft side end portion of the first main body portion, is located in an axially shifted position that is shifted from the second-shaft side end of the first main body portion, in a direction which is away from the second shaft and which is parallel to an axial direction parallel to the axis of the first shaft and the axis of the second shaft.

(14) The steering-force transmitting apparatus according to mode (13), wherein the radially protruding portion has axially opposite ends such that one of the axially opposite ends of the radially protruding portion is closer to the second shaft than the other of the axially opposite ends of the radially protruding portion, wherein the one of the axially opposite ends of the radially protruding portion is distant from the second-shaft side end of the first main body portion by a predetermined axial distance as measured in the axial direction, and wherein the predetermined axial distance is at least one-third as large as an outside diameter of the second-shaft side end portion of the first main body portion from which the radially protruding portion protrudes.

In the apparatus according to each of the above modes (13) and (14), the radially protruding portion, which protrudes from the second-shaft side end portion of the first main body portion, is located in the axially shifted position that is shifted from the second-shaft side end of the first main body portion, in the above-described direction which is away from the second shaft and which is parallel to the axial direction. As compared with an arrangement in which the radially protruding portion is located in a non-shifted position that is not shifted from the second-shaft side end of the first main body portion, this arrangement permits an entire axial length of the first main body portion to be made larger by an amount corresponding to a shift distance by which the above-described axially shifted position is sifted from the end-shaft side end of the first main body portion. In other words, this arrangement permits the first main body portion to be located in a position that is shifted by an amount corresponding to the shift distance in a direction which is toward the above-described one of the axially opposite end portions of the second shaft and which is parallel to the axial direction. Therefore, in the apparatus according to each of the above modes (13) and (14), it is possible to further reduce the entire axial length of the steering-force transmitting apparatus provided with the rotation transmitting mechanism.

(15) The steering-force transmitting apparatus according to mode (13) or (14), further including a tubular-shaped housing that is fixed to a part of a body of the vehicle, wherein the second shaft is rotatably supported, at the second main body portion, by the housing, wherein the second main body portion is extensible and contractible in directions parallel to the axis of the second shaft, wherein the tubular-shaped housing includes: a first tubular member; and a second tubular member having a small diameter portion, a large diameter portion and a stepped portion that interconnects the large and small diameter portions, the small diameter portion having an outside diameter smaller than an inside diameter of the first tubular member, the large diameter portion having an outside diameter larger than the inside diameter of the first tubular member, wherein the small diameter portion of the second tubular member is introduced into the first tubular member from an axial end portion of the first tubular member, so as to be fitted in the first tubular member, such that the first and second tubular members are slidingly movable relative to each other whereby the tubular-shaped housing is extensible and contractible, and such that contraction of the tubular-shaped housing is limited upon contact of the axial end portion of the first tubular member with the stepped portion of the second tubular member, wherein the second main body portion is rotatably supported by cooperation of the first tubular member and the small diameter portion of the second tubular member, while the radially projecting portion is accommodated in the large diameter portion of the second tubular member.

Where the steering-force transmitting apparatus is constituted as a steering column, it is common that the operating-member-side shaft and a housing supporting the operating-member-side shaft are adapted to be extensible and contractible, for absorbing an impact caused by a secondary collision between the vehicle operator and the steering operation member, which could occur as a result of a primary collision between the vehicle and another object. Commonly, the housing is constituted by two tubular members, for example, an inner tube and an outer tube that is fitted on the inner tube, such that the housing is extensible and contractible. Further, since the radially projecting portion projects from the main body portion in the radial direction, it is common that the housing is a stepped housing having a small diameter portion, a large diameter portion and a stepped portion that interconnects the large and small diameter portions, such that the radially projecting portion is accommodated in the large diameter portion while the main body portion is accommodated in the small diameter portion. In the event of the secondary collision, contraction of the housing is limited by contact of an axial end portion of the outer tube with the stepped portion of the inner tube. Where the operating-member-side shaft is accommodated in the housing constructed as described above, the stepped portion of the housing can be located in a more front position, by locating the radially projecting portion in a more front position, so that it is possible to increase a stroke distance by which the housing is extensible and contractible. That is, the stroke distance can be increased with reduction of a distance between a front end of the vehicle and a position of the radially protruding portion that is introduced in the guide passage of the radially projecting portion. In the apparatus according to this mode (15), the stroke distance of the operating-member-side shaft and the housing can be made relatively large, thereby making it possible to increase performance for absorbing the impact caused by the secondary collision.

### BRIEF DESCRIPTION OF DRAWINGS

The above and other objects, features, advantages and technical and industrial significance of the present invention will be better understood by reading the following detailed description of presently preferred embodiment of the invention, when considered in connection with the accompanying drawings, in which:

FIG. 1 is a view schematically showing a vehicle steering system provided with a steering-force transmitting apparatus that is constructed according to an embodiment of the claimable invention;

FIG. 2 is a cross sectional view showing the steering-force transmitting apparatus that is provided in the vehicle steering system of FIG. 1;

FIG. 3 is a cross sectional view showing an EPS section that is provided in the steering-force transmitting apparatus;

FIG. 4 is a cross sectional view taken along line IV-IV of FIG. 3;

FIG. 5 is a perspective view showing a breakaway bracket holding a column section that is provided in the steering-force transmitting apparatus;

FIG. 6 is a set of cross sectional views taken along line IV-IV of FIG. 3 and showing four stages in operation of a steering wheel;

FIG. 7 is a graph showing a relationship between a rotational angle of an operating-member-side shaft and a rotational angle of a turning-device-side shaft;

FIG. 8 is a graph showing a gear ratio of the turning-device-side shaft to the operating-member-side shaft, which is changed depending on a rotational angle of the operating-member-side shaft;

FIG. 9 is a set of views showing the steering-force transmitting apparatus according to the embodiment, as compared with a steering-force transmitting apparatus as a comparative example;

FIG. 10 is a cross sectional view showing an EPS section that is provided in a steering-force transmitting apparatus constructed according to a modification of the embodiment of the claimable invention;

FIG. 11 is a cross sectional view taken along line XI-XI of FIG. 10; and

FIG. 12 is a set of cross sectional views taken along line XI-XI of FIG. 10 and showing four stages in operation of a steering wheel.

### BEST MODE FOR CARRYING OUT THE INVENTION

There will be described an embodiment of the present invention, by reference to the accompanying drawings. It is to be understood that the present invention is not limited to the following embodiment, and may be otherwise embodied with various changes and modifications, such as those described in the foregoing “MODES OF THE INVENTION”, which may occur to those skilled in the art.

### <Overall Construction of Steering System>

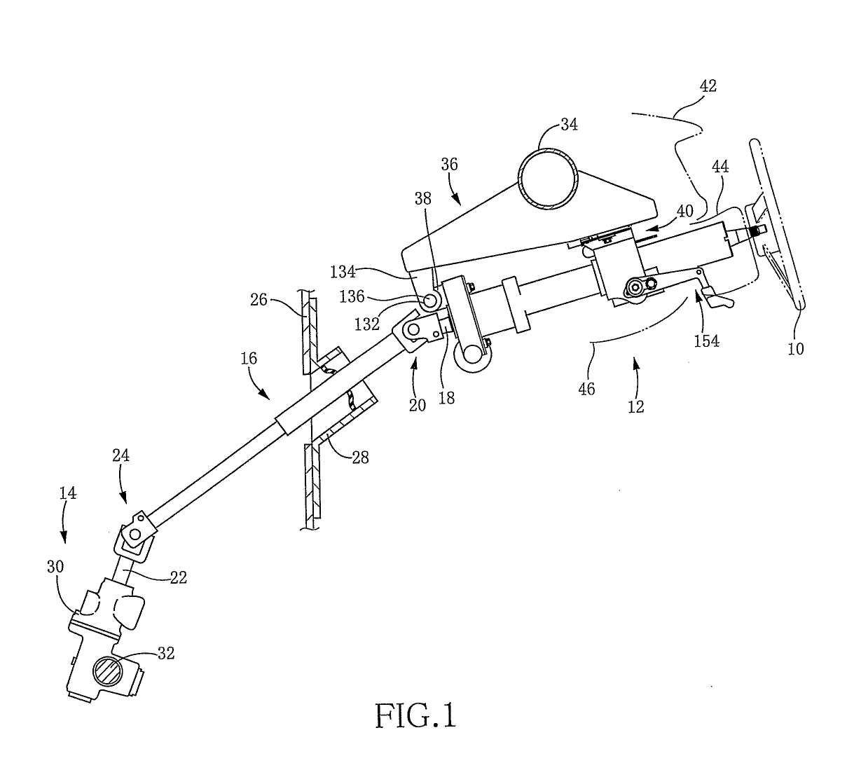

FIG. 1 shows an overall construction of a vehicle steering system that is to be installed on a vehicle. The vehicle steering system is provided with a steering-force transmitting apparatus that is constructed according to a first embodiment of the invention. The present steering system includes: a steering wheel 10 as a steering operation member operable by an operator of the vehicle; a steering-force transmitting apparatus 12; a wheel turning device 14 configured to turn wheels of the vehicle; and an intermediate shaft 16 that is disposed between the steering-force transmitting apparatus 12 and the wheel turning device 14. The steering wheel 10 is held by an axial end portion of the steering-force transmitting apparatus 12. A universal joint 20 is provided to interconnect an axial end portion of the intermediate shaft 16 and an output shaft 18 that is included in the steering-force transmitting apparatus 12. Meanwhile, another universal joint 24 is provided to interconnect another axial end portion of the intermediate shaft 16 and an axial end portion of an input shaft 22 of the wheel turning device 14.

The present vehicle steering system is installed on the vehicle such that its portion closer to the steering wheel 10, i.e., its right-side portion as seen in FIG. 1 is located on a rear side of its portion closer to the wheel turning device 14, i.e., left-side portion as seen in FIG. 1. The intermediate shaft 16 passes through a through-hole formed through a dash panel 26 which separates an engine room and a passenger compartment from each other. A boot 28 is provided to cover a portion of the intermediate shaft 16 which portion is adjacent to the through-hole of the dash panel 26.

The wheel turning device 14 includes a housing 30 and a steering rod 32 configured to steer the wheels, in addition to the above-described input shaft 22. The steering rod 32 is held by the housing 30 such that the steering rod 32 extends in a lateral direction of the vehicle and such that the steering rod 32 is movable in its axial direction. The steering rod 32 is connected at its axially opposite end portions to respective steering knuckles (not shown) that hold the respective right and left wheels. Meanwhile, the input shaft 22 is rotatably held by the housing 30, and is held in engagement with the steering rod 32 inside the housing 30. A pinion (not shown) is provided in a front or lower end portion of the input shaft 22, and meshes with a rack (not shown) that is provided in an axially intermediate portion of the steering rod 32, so that the input shaft 22 and the steering rod 32 are held in engagement with each other.

The steering-force transmitting apparatus 12 is constituted as a so-called steering column, and is fixedly supported by a part of a body of the vehicle, via a steering support 36 that is provided on an instrument panel reinforcement 34 of the vehicle. The steering-force transmitting apparatus 12, which is thus supported by the part of the vehicle body, takes a posture such that a front side portion of the apparatus 12 is located on a lower side of a rear side portion of the apparatus 12, as shown in FIG. 1. A front bracket 38 and a breakaway bracket 40 are provided in the steering-force transmitting apparatus 12 such that the front bracket 38 is located on a front side of the breakaway bracket 40 while the breakaway bracket 40 is located on a rear side of the front bracket 38. The front bracket 38 and the breakaway bracket 40 are attached to the steering support 36 whereby the steering-force transmitting apparatus 12 is supported at its two portions by the part of the vehicle body. The thus supported steering-force transmitting apparatus 12 has a rear end portion which protrudes from an instrument panel 42 in a rearward direction, such that the steering wheel 10 is attached to a rearmost end of the rear end portion of the apparatus 12. A column cover 44 is provided to cover a majority of the rear end portion of the steering-force transmitting apparatus 12, which protrudes from the instrument panel 42. Further, an instrument panel lower cover 46 is provided to cover a lower portion of the rear end portion of the steering-force transmitting apparatus 12.

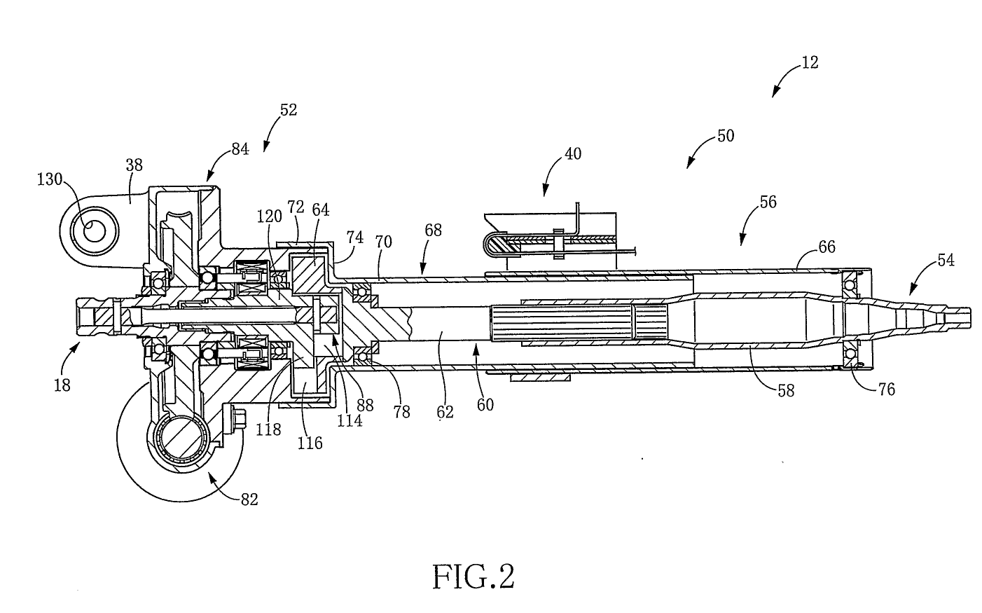

FIG. 2 is an axially cross-sectional view of the steering-force transmitting apparatus 12. The steering-force transmitting apparatus 12 can be sectioned into a column section 50 and an EPS section 52. The column section 50 holds the steering wheel 10, and is extensible and contractible in its axial direction. The EPS section 52 is a main section configured to achieve an electric power steering function. The two sections 50, 52, which are integral with each other, will be described.

The column section 50 includes an operating-member-side shaft in the form of a main shaft 54 and a tubular-shaped housing in the form of a column tube 56. The main shaft 54 has a rear end portion (as one of its axially opposite end portions) to which the steering wheel 10 is fixedly connected, so that the main shaft 54 serves as the operating-member-side shaft that holds the steering wheel 10. The main shaft 54 is introduced in the column tube 56, and is rotatably held by the column tube 56, so that the column tube 56 serves as the tubular-shaped housing that rotatably holds the main shaft 54. The main shaft 54 includes an upper shaft 58 and a lower shaft 60 such that the upper shaft 58 is provided by a rear or upper portion of the main shaft 54 while the lower shaft 60 is provided by a front or lower portion of the main shaft 54. The upper shaft 58 is a tube shaft while the lower shaft 60 is a solid shaft. A rear end portion of the lower shaft 60 is introduced in a front end portion of the upper shaft 58. The upper shaft 58 has a splined inner circumferential surface while the lower shaft 60 has a splined outer circumferential surface, so that the upper and lower shafts 58, 60 are held in spline engagement with each other. Thus, the upper and lower shafts 58, 60, which are connected to each other, are movable in the axial direction relative to each other and unrotatable relative to each other, so that the main shaft 54 is extensible and contractible in its axial direction. The lower shaft 60 includes a lower-shaft main body portion 62 and a circular-shaped flange portion 64 as a radially projecting portion. The lower-shaft main body portion 62 is provided by a rear or upper portion of the lower shaft 60. The flange portion 64 is provided by a front or lower portion of the lower shaft 60, so as to be located on a front or lower side of the lower-shaft main body portion 62. The flange portion 64 as the radially projecting portion has an outside diameter that is larger than an outside diameter of the lower-shaft main body portion 62. The lower shaft 60 is connected at the circular-shaped flange portion 64 to the EPS section 52 that will be described later in detail. In the present steering-force transmitting apparatus 12, the lower-shaft main body portion 62 of the lower shaft 60 cooperates with the upper shaft 58 to constitute a main body portion of the main shaft 54.

The column tube 56 includes an upper tube 66 as a first tubular member and a lower tube 68 as a second tubular member, such that the upper tube 66 is located on a rear or upper side of the lower tube 68 and such that the lower tube 68 is located on a front or lower side of the upper tube 66, and such that a rear end portion of the lower shaft 60 is introduced in a front end portion of the upper shaft 58. The lower tube 68, which is thus fitted in the upper tube 66, is a stepped tube having a small diameter portion 70, a large diameter portion 72 and a stepped portion 74 that interconnects the small and large diameter portions 70, 72. The small diameter portion 70 has an outside diameter smaller than an inside diameter of the upper tube 66, and is provided by a rear or upper portion of the lower tube 68. The large diameter portion 72 has an outside diameter larger than the inside diameter of the upper tube 66, and is provided by a front or lower portion of the lower tube 68. A liner (not shown) is provided between the small diameter portion 70 of the lower tube 68 and the upper tube 66. Owing to the provision of the line, the lower tube 68 is fitted in the upper tube 66 without play between the two tubes 66, 68, and the upper and lower tubes 66, 68 are easily movable relative to each other. Thus, the column tube 56 is adapted to be extensible and contractible in the axial direction.

Radial bearings 76, 78 are provided in a rear end portion of the upper tube 66 and a front end portion of the lower tube 68, respectively, so that the main shaft 54 is rotatably supported by the column tube 56 via the bearings 76, 78. Thus, the column section 50 as a whole is extensible and contractible while permitting rotation of the main shaft 54.

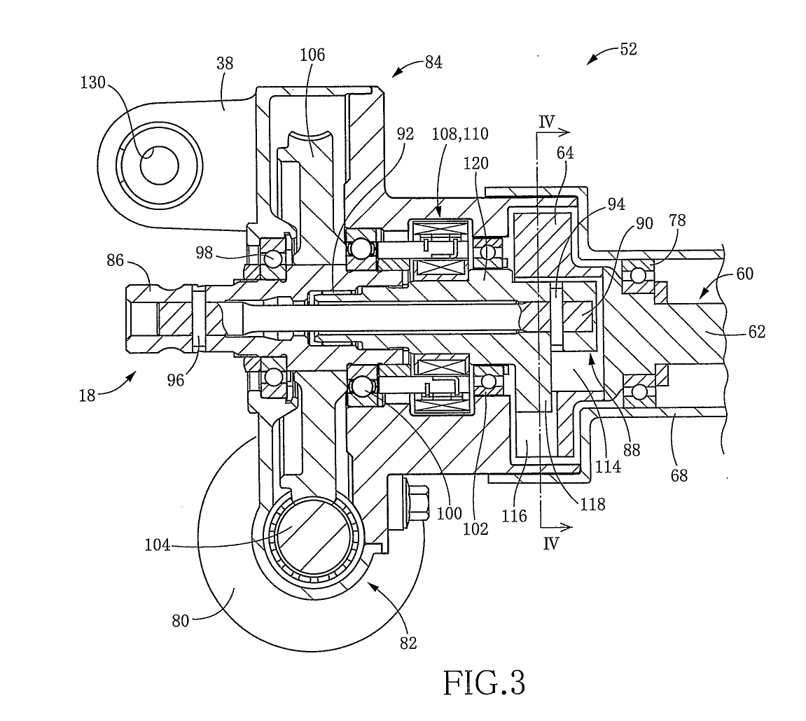

FIG. 3 shows an axially cross-sectional view of the EPS section 52, which includes an assisting device 82 and an EPS housing 84 in addition to the output shaft 18. The output shaft 18 is configured to output an operating force applied to the steering wheel 10, whereby the operating force is transmitted to the wheel turning device 14 via the output shaft 18. The assisting device 82 has an electromagnetic motor 80 as a power source, and is configured to assist a rotational output of the output shaft 18, owing to activation of the motor 80. The EPS housing 84 rotatably holds the output shaft 18, and accommodates the assisting device 82 therein. The output shaft 18 as a turning-device-side shaft includes an output-side shaft 86 as a second hollow shaft, an input-side shaft 88 as a first hollow shaft and a torsion bar 90 that are integral with each other. The output-side shaft 86 includes a projecting portion projecting from a front portion of the EPS housing 84, and is connected at the projecting portion thereof to the intermediate shaft 16 via the universal joint 20, so as to transmit rotation to the wheel turning device 14.

The input-side shaft 88 is introduced in a rear portion of the output-side shaft 86 that is a hollow shaft. A bearing 92 is interposed between an inner circumferential surface of the output-side shaft 86 and an outer circumferential surface of the input-side shaft 88, whereby the output-side shaft 86 and the input-side shaft 88 are rotatable relative to each other while maintaining a coaxial relationship. The input-side shaft 88 has a blind hole which extends in the axial direction and which opens in a front-side one of axially opposite end surfaces of the input-side shaft 88. The output-side shaft 86 has a through-hole which extends in the axial direction. The torsion bar 90 is disposed in a space which is provided by cooperation of the blind hole of the input-side shaft 88 and the through-hole of the output-side shaft 86, namely, which is defined by cooperation of the output-side shaft 86 and the input-side shaft 88. An axial end portion of the torsion bar 90 is fixed to a bottom portion of the blind hole of the input-side shaft 88 via a pin 94. Another axial end portion of the torsion bar 90 is fixed to a front end portion of the through-hole of the output-side shaft 86 via a pin 96. Owing to such a construction, the output shaft 18 allows twisting deformation of the torsion bar 90, and the output shaft 18 as a whole is allowed to be twisted by an amount corresponding to an amount of the twisting deformation of the torsion bar 90. The output-side shaft 86 is rotatably held at its outer periphery by the EPS housing 84 via two bearings 98, 100. The input-side shaft 88 is rotatably held at its outer periphery by the EPS housing 84 via a bearing 102.

The assisting device 82 includes a worm 104 and a worm wheel 106 in addition to the above-described electromagnetic motor 80. The worm 104 is connected to a drive shaft of the electromagnetic motor 80, and meshes with the worm wheel 106. The worm wheel 106 is fixed to the output-side shaft 86 of the output shaft 18, so as to be unrotatable relative to the output-side shaft 86. Owing to such a construction, a rotational force is applied from the electromagnetic motor 80 to the worm wheel 106 via the worm 104. That is, the assisting device 82 is configured to cause the electromagnetic motor 80 to generate a wheel-turning assisting force (that may be referred also to as “steering assisting force”) that is to assist a rotational output of the output shaft 18 so as to assist the wheels to be turned.

The EPS section 52 includes two resolvers 108, 110. The resolver 108 is provided between an inner surface of the EPS housing 84 and the output-side shaft 86 (to which the above-described another axial end portion of the torsion bar 90 is fixed), so as to detect a rotational angular position of the output-side shaft 86. The resolver 110 is provided between the inner surface of the EPS housing 84 and the input-side shaft 88 (to which the above-described axial end portion of the torsion bar 90 is fixed), so as to detect a rotational angular position of the input-side shaft 88. It is there possible to detect, based on detection signals supplied from the resolvers 108, 110, a relative rotational displacement amount that is a difference between the rotational angular position of the output-side shaft 86 and the rotational angular position of the input-side shaft 88, and to estimate a steering torque, based on the relative rotational displacement amount. The electromagnetic motor 80 is controlled so as to generate the wheel-turning assisting force such that an amount of the generated wheel-turning assisting force is dependent on an amount of the steering torque.

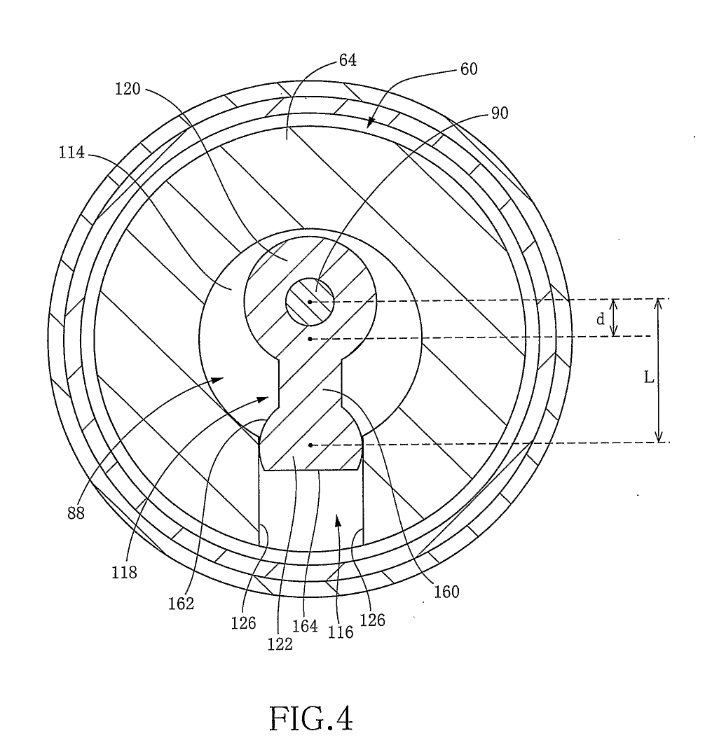

The output shaft 18 is connected to a front end portion of the main shaft 54, such that a rotation axis of the output shaft 18 and a rotation axis of the main shaft 54 are parallel to each other, and are offset from each other by a predetermined offset distance d. Described in detail, the lower shaft 60, which constitutes a part of the main shaft 54, has a recess 114 that opens in a surface of a front end of the circular-shaped flange portion 64, and a rear end portion of the input-side shaft 88, which constitutes a part of the output shaft 18, is accommodated in the recess 114. As shown in FIG. 4 that is a cross sectional view taken along line IV-IV of FIG. 3, a radially extending groove 116 is provided in the front end surface of the flange portion 64 of the lower shaft 60, so as to extend from the recess 114 in a radial direction of the lower shaft 60. Meanwhile, the input-side shaft 88 includes an input-side shaft main body portion 120 and a radially protruding portion 118 protruding radially from an accommodated portion of the input-side shaft main body portion 120 which is accommodated in the recess 114. The radially protruding portion 118 is introduced in the radially extending groove 116 via a connected portion of the recess 114 at which the recess 114 is connected to the radially extending groove 116. As shown in FIGS. 3 and 4, the input-side shaft 88 is constituted by the input-side shaft main body portion 120 and the radially protruding portion 118. The input-side shaft main body portion 120 extends in a direction of the rotation axis of the output shaft 18, while the radially protruding portion 118 protrudes from the main body portion 120 in a direction perpendicular to the rotation axis of the output shaft 18. The radially protruding portion 118 is located in an axially shifted position that is shifted from a rear end of the main body portion 120, in a forward direction, in a direction away from the main shaft 54. The radially protruding portion 118 has a radially distal end portion serving as an engaging portion 122 that is engaged in the radially extending groove 116. It is noted that, in the present steering-force transmitting apparatus 12, the input-side shaft main body portion 120 of the input-side shaft 88 cooperates with the output-side shaft 86 to constitute a main body portion of the output shaft 18.

The main shaft 54 is rotated about its rotation axis when the steering wheel 10 is operatively rotated by the operator of the vehicle. In this instance, the engaging portion 122, which is engaged in the radially extending groove 116 provided in the circular-shaped flange portion 64 of the lower shaft 60, is limited by a pair of side wall surfaces 126 of the radially extending groove 124, from being displaced in a circumferential direction of the lower shaft 60, but is allowed to be displaced in a radial direction of the lower shaft 60. That is, the pair of side wall surfaces 126 serve as a pair of guide surfaces, so that the groove 116 serves as a guide passage. When the engaging portion 122 of the input-side shaft 88 is moved in the groove 116 as a result of rotation of the lower shaft 60, the rotational force is transmitted from the lower shaft 60 to the main body portion 120 of the input-side shaft 88 via the radially protruding portion 118, whereby the input-side shaft 88 is rotated about its rotation axis. Thus, the steering-force transmitting apparatus 12 is equipped with a rotation transmitting mechanism that is configured to transmit the rotation of the lower shaft 60 about its rotation axis to the input-side shaft 88, whereby the input-side shaft 88 is rotated about its rotation axis that is offset from the rotation axis of the lower shaft 60 by a predetermined offset distance. Owing to such a construction, the steering-force transmitting apparatus 12 is configured to transmit a steering force that is applied to the steering wheel 10, to the wheel turning device 14 via components such as the intermediate shaft 16. It is noted that, in the present steering-force transmitting apparatus 12, the rotation transmitting mechanism is constituted by cooperation of the engaging portion 122 and the radially extending groove 116 that is provided in the circular-shaped flange portion 64 of the lower shaft 60.

The steering-force transmitting apparatus 12 is attached at a front end portion of the EPS section 52 and the upper tube 66 of the column 50, to a part of the vehicle body. The above-described front bracket 38 is fixedly disposed in the EPS housing 84 of the EPS section 52. The front bracket 38 has a shaft receiving hole 130 (see FIG. 2). A shaft receiving member 134 having a shaft receiving hole 132 is fixed to the steering support 36 (see FIG. 1), so that the steering-force transmitting apparatus 12 is held by the part of the vehicle body and is pivotable about a support shaft 136 that is introduced in the shaft receiving hole 130 of the front bracket 38 and the shaft receiving hole 132 of the shaft receiving member 134.

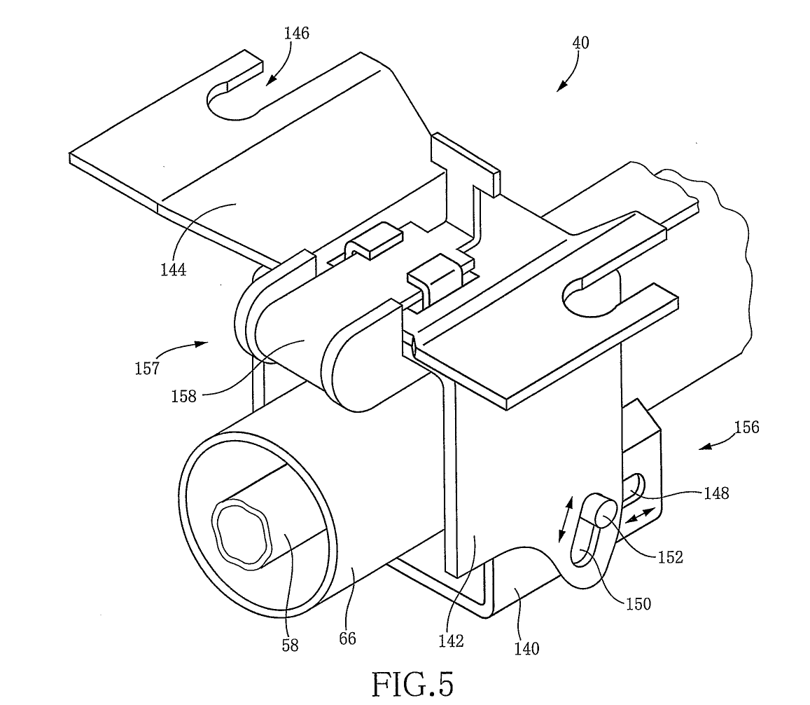

Meanwhile, the column section 50 is held by the breakaway bracket 40 that is attached to the steering support 36. Described more in detail, as shown in FIG. 5, the breakaway bracket 40 includes an inverted U-shaped holding member 142 and an attachment plate 144. The holding member 142 is provided to hold a tube receiving member 140 that is fixed to the upper tube 66. The attachment plate 144 is fixed to the holding member 142, and is attached to the steering support 36. The breakaway bracket 40 is fastened to the steering support 36, by using slots 146 that are provided in the attachment plate 144. The tube receiving member 140 and the inverted U-shaped holding member 142 have elongated holes 148, 150, respectively. The tube receiving member 140 is gripped by the inverted U-shaped holding member 142, by using a rod 152 that extends through the elongated holes 148, 150. The tube receiving member 140 is gripped by the holding member 142 by a gripping force, by which the upper tube 66 is inhibited from being displaced. The griping force can be reduced by operating an operating lever 154. When the gripping force is reduced by operation of the operating lever 154, the rod 152 is allowed to be moved along the elongated hole 148 and also along the elongated hole 150. As the rod 152 is allowed to be moved along the elongated hole 148, the upper tube 66 is allowed to be moved relative to the lower tube 68 in the axial direction, together with movement of the upper shaft 58 relative to the lower shaft 60 in the axial direction, whereby the column section 50 as a whole is allowed to be extended and contacted. Meanwhile, as the rod 152 is allowed to be moved along the elongated hole 150, the steering steering-force transmitting apparatus 12 is allowed to be pivoted about the support shaft 136 that is introduced in the front bracket 38. Thus, the present steering-force transmitting apparatus 156 is equipped with a tilt/telescopic mechanism 56 that is constructed as described above.

In the event of a secondary collision between the operator of the vehicle and the steering wheel 10 which could occur as a result of a primary collision between the vehicle and another object, the breakaway bracket 40 is removed from the steering support 36, and the column section 50 is contracted. The steering-force transmitting apparatus 12 is provided with an impact absorbing mechanism 157 that is configured to absorb an impact caused by the secondary collision. The impact of the secondary collision is effectively absorbed by causing an EA plate (U-shaped plate) 158 to be deformed together with contraction of the steering column 56.

### <Function of Rotation Transmitting Mechanism>

In the present steering-force transmitting apparatus 12, the two shafts 60, 88 are positioned relative to each other such that axes of the respective two shafts 60, 88 are offset from each other, and are connected to each other through the rotation transmitting mechanism. Owing to this offset arrangement, a rotational phase of the lower shaft 60 and a rotational phase of the input-side shaft 88 are offset from each other, such that a rotational phase difference between the rotational phases of the respective two shafts 60, 88 is changeable.

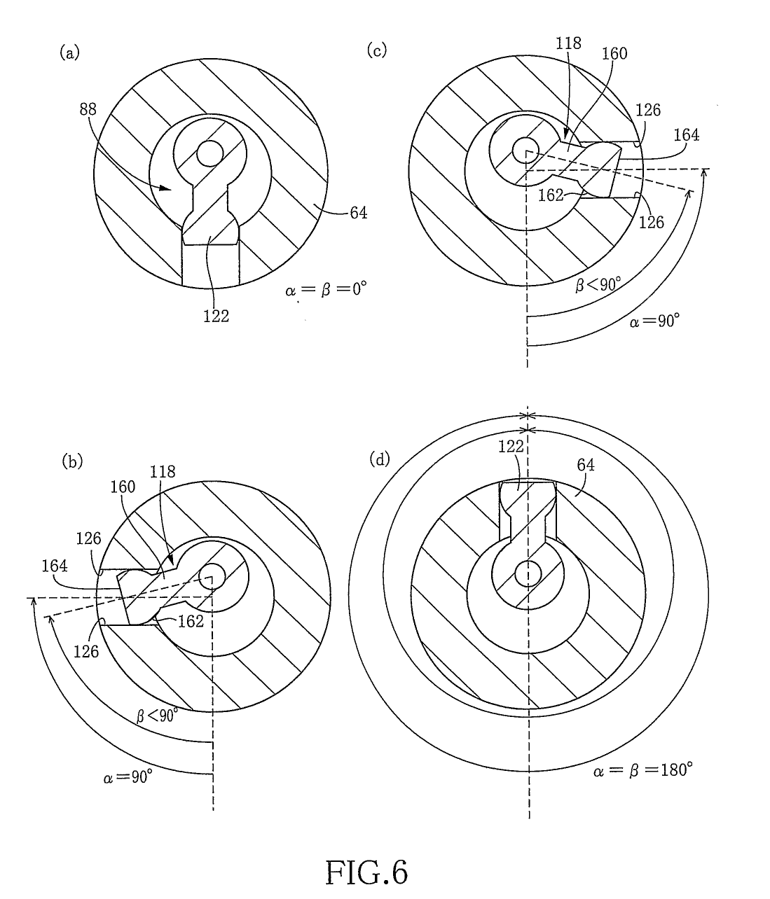

FIG. 6 is a set of cross sectional views (a)-(d) taken along line IV-IV of FIG. 3 and showing the circular-shaped flange portion 64 of the lower shaft 60 and the input-side shaft 88 connected to the flange portion 64. The view (a) of FIG. 6 shows a stage in which the steering wheel 10 is positioned in its neutral operating position that causes the wheels to be held without turning. The view (b) of FIG. 6 shows a stage in which the steering wheel 10 has been operatively rotated by 90° in counterclockwise direction from the neutral operating position. The view (c) of FIG. 6 shows a stage in which the steering wheel 10 has been operatively rotated by 90° in clockwise direction from the neutral operating position. The view (d) of FIG. 6 shows a stage in which the steering wheel 10 has been operatively rotated by 180° in clockwise or counterclockwise direction from the neutral operating position.

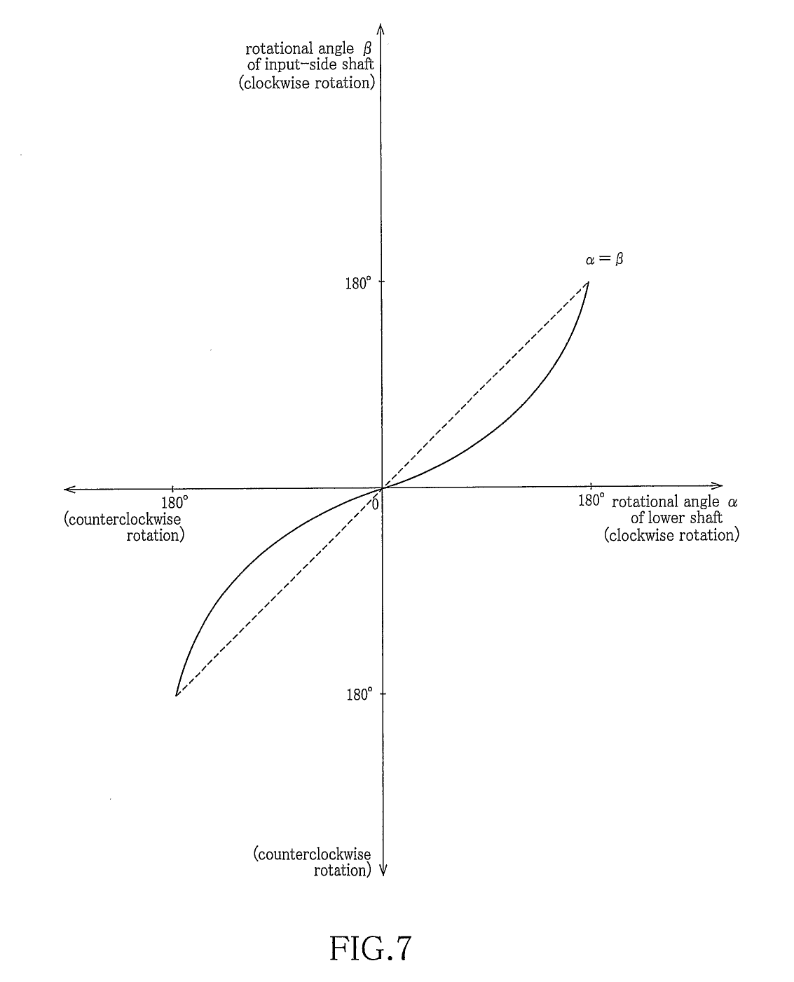

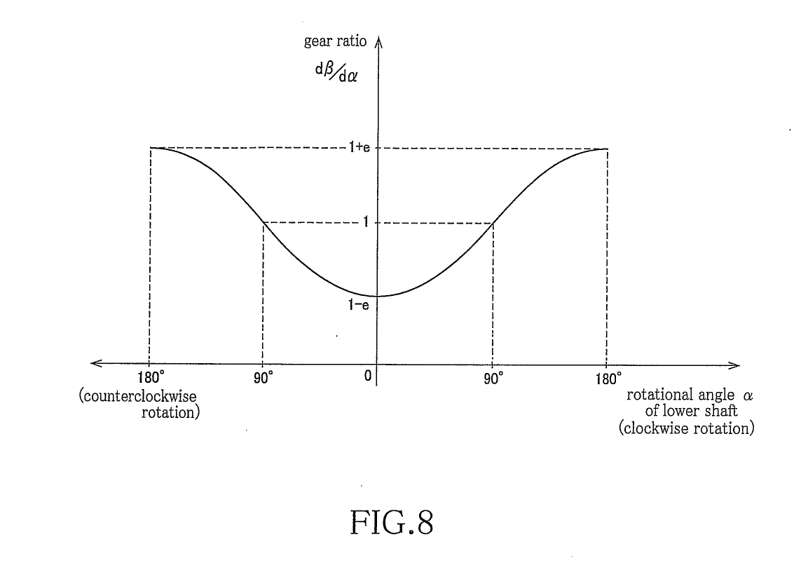

As is understood from the views (a)-(d) of FIG. 6, when the steering wheel 10 is rotated by 90° in clockwise or counterclockwise direction from the neutral operating position, the lower shaft 60 is rotated about its rotation axis by 90° while the input-side shaft 88 is rotated about its rotation axis by an amount smaller than 90°. When the steering wheel 10 is rotated by 180° in clockwise or counterclockwise direction from the neutral operating position, the lower shaft 60 and the input-side shaft 88 are both rotated by 180°. FIG. 7 shows a relationship between a rotational angle α of the lower shaft 60 and a rotational angle β of the input-side shaft 88. As is apparent from FIG. 7, when the steering wheel 10 is rotated from the neutral operating position by an amount smaller than 180°, the rotational angle β of the input-side shaft 88 is smaller than the rotational angle α of the lower shaft 60. When the steering wheel 10 is rotated from the neutral operating position by 180°, the rotational angle β of the input-side shaft 88 becomes equal to the rotational angle α of the lower shaft 60. That is, when the rotational angle α of the lower shaft 60 is 0° or 180°, namely, when the rotational phase of the lower shaft 60 is either one of two predetermined values which cause the rotational phase of the lower shaft 60 and the rotational phase of the input-side shaft 88 to coincide with each other, the rotational angle α of the lower shaft 60 and the rotational angle β of the input-side shaft 88 are equalized to each other whereby the rotational phase difference becomes zero. As shown in FIG. 7, during change of the rotational angle α of the lower shaft 60 from 0° to 180°, the rotational phase difference is gradually increased until the rotational angle α of the lower shaft 60 becomes a certain value, and is then gradually reduced to zero after the angle α of the lower shaft 60 becomes the certain value. When the rotational angle α of the lower shaft 60 becomes 180°, the rotational phase difference becomes zero. During the change of the rotational angle α of the lower shaft 60 from 0° to 180°, a gear ratio (dβ/dα) between angular speeds of the respective rotated two shafts, i.e., a ratio (dβ/dα) of a rotational speed (dβ/dt) of the input-side shaft 88 (as the turning-device-side shaft) to a rotational speed (dα/dt) of the lower shaft 60 (as the operating-member-side shaft) is changed depending on the rotational angle α of the lower shaft 60, as shown in FIG. 8.

As is understood from FIG. 8, the gear ratio (dβ/dα) is minimized when the rotational angle α of the lower shaft 60 is 0°, and is increased with increase of the rotational angle α of the lower shaft 60. That is, in the present steering-force transmitting apparatus 12, a moderate and stable steering performance is obtained in a stage in which an operating angle of the steering wheel 10 is small, and then a highly responsive steering performance is obtained in a stage in which the operating angle of the steering wheel 10 is large. In other words, a degree of response of the steering performance is increased with increase of the operating angle of the steering wheel 10. It is noted that the present steering system is equipped with an operating range limiting mechanism (not shown) that is configured to limit a range of the operating angle of the steering wheel 10 such that the steering wheel 10 is allowed to be clockwise and counterclockwise rotated from the neutral operating position by 180° as an allowable maximum operating angle.

In graph of FIG. 8, an axis of ordinates represents the gear ratio (dβ/dα) as the ratio of the rotational speed of the input-side shaft 88 to the rotational speed of the lower shaft 60, wherein “e” represents a ratio of the above-described predetermined offset distance d (by which the axes of the respective input-side shaft 88 and lower shaft 60 are offset from each other, as shown in FIG. 4) to the deviation distance L (by which a position of the engaging portion 122 engaged in the radially extending groove 116 is deviated or distant from the rotation axis of the input-side shaft 88, as shown in FIG. 4). An operation feeling provided to the vehicle operator who operates the steering wheel 10 varies depending on a value of this ratio e.

Since the rotation axes of the respective two shafts 60, 88 are offset from each other, there are stages in which the radial direction of the lower shaft 60 and the radial direction of the input-side shaft 88 are deviated from each other, namely, the direction in which the side wall surfaces 126 extend and the direction in which the radially protruding portion 118 protrude are deviated from each other, as shown in views (b), (c) of FIG. 6. For avoiding contact or interference of the radially protruding portion 118 with a radially inner end portion of each of the side wall surfaces 126, the radially protruding portion 118 has a small-width portion 160 that is located between a radially proximal end portion of the radially protruding portion 118 and the engaging portion 122. The small-width portion 160 has a width smaller than a width of the engaging portion 122, as measured in a circumferential direction of the input-side shaft 88. Further, the engaging portion 122 has a cylindrical surface 162 defined by cooperation of contact surfaces of the engaging portion 122 at which the engaging portion 122 is held in contact with the respective side wall surfaces 126, such that the cylindrical surface 162 has an outside diameter that is slightly smaller than a distance between the pair of the side wall surfaces 126, as measured in the circumferential direction. Owing to this arrangement, independently of the rotational angles of each of the shafts 60, 88, the engaging portion 122 is constantly held in sliding contact at its cylindrical surface 162 with the side wall surfaces 126, with no substantial play between the cylindrical surface 162 and each of the side wall surfaces 126, thereby making it possible to assure smooth transmission of rotation from each one of the shafts 60, 88 to the other.

A distal end of the engaging portion 122, which is not brought into contact with the side wall surfaces 126, is defined by a flat surface 164, such that the engaging portion 122 does not protrude outwardly from an outer circumferential surface of the flange portion 64 even in the stage in which the steering wheel 10 is operatively rotated by 180°, as shown in view (d) of FIG. 6. Further, the cylindrical surface 162 is configured, such that the cylindrical surface 162 is brought into contact, at its portion contiguous to the flat surface 164, with one of the side wall surfaces 126, when the rotational phase difference between the rotational phases of the respective two shafts 60, 88 is maximized.

<Advantages of Present Steering-Force Transmitting Apparatus over Other Steering-Force Transmitting Apparatus>

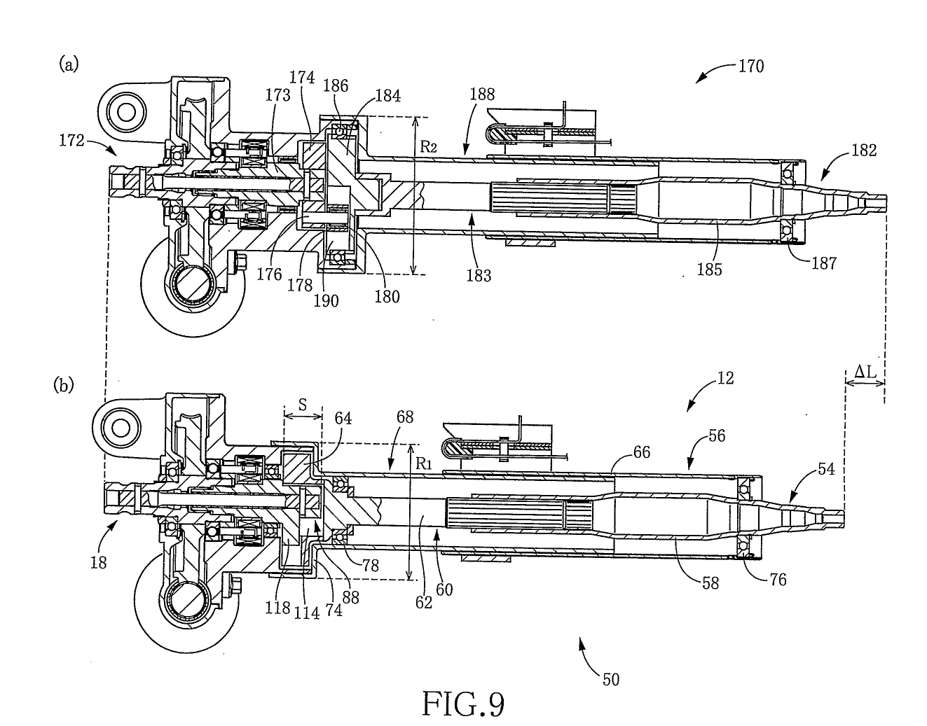

In the steering-force transmitting apparatus 12, a rear end of a main body portion of a first shaft in the form of the output shaft 18 is located on a rear side of a front end of a second shaft in the form of the main shaft 54, in an axial direction that is parallel to the rotation axis of the output shaft 18 and the rotation axis of the main shaft 54, as shown in FIGS. 2 and 3. In other words, the rear end of the main body portion of the output shaft 18 is located between the front end of the main shaft 54 and a rear end of the main shaft 54 in the axial direction. It is noted that, in the present apparatus 12, the rear end of the input-side shaft 88 corresponds to a second-shaft side end of a first main body portion, while the front end of the main shaft 54 corresponds to a first-shaft side end of the second shaft. FIG. 9 is a set of views showing the steering-force transmitting apparatus 12 (in which the main shaft 54 and the output shaft 18 are positioned relative to each other as described above) and another steering-force transmitting apparatus 170 as a comparative example.

In the steering-force transmitting apparatus 170 shown in the view (a) of FIG. 9, a main shaft 182 and an output shaft 172 are positioned relative to each other such that a rear end of a main body portion of the output shaft 172 and a front end of the main shaft 182 are opposed to each other and spaced apart from each other by a small distance. In the apparatus 170, described in detail, an annular-shaped plate 174 is fixedly fitted on a rear end portion of an input-side shaft 173 that constitutes a part of the output shaft 172. A pin 176 is fixedly provided in the annular-shaped plate174, so as to protrude in a reward direction. A roller 180 is mounted on an axially projecting portion of the pin 176 with a needle bearing 178 interposed therebetween. A lower shaft 183 constituting a part of the main shaft 182 has a circular-shaped flange portion 184 that is located in a front end portion of the lower shaft 183. The main shaft 182 is rotatably supported, at the circular-shaped flange portion 184 and a rear end portion of an upper shaft 185 (that constitutes a part of the main shaft 182), by a housing 188 of the apparatus 170 via radial bearings 186, 187. A rear end surface of the annular-shaped plate174 and a front end surface of the circular-shaped flange portion 184 of the lower shaft 183 are opposed to each other, and are spaced apart from each other by a small distance. A radially extending groove 190 is formed in the front end surface of the circular-shaped flange portion 184, and is located in a position opposed to the roller 180 that protrudes from the annular-shaped plate 174 in the rearward direction. The radially extending groove 190 extends from a center of the front end surface of the circular-shaped flange portion 184 in a radial direction of the flange portion 184, and has a width that is slightly larger than an outside diameter of the roller 180. With engagement of the roller 180 in the radially extending groove 190, the lower shaft 183 and the input-side shaft 173 are connected to each other, whereby the output shaft 172 is rotatable by rotation of the main shaft 182.

The two shafts 173, 183 are positioned relative to each other such that rotary axes of the respective two shafts 173, 183 are offset from each other by an offset distance that is equal to the above-described offset distance d (by which the rotary axes of the respective two shafts 60, 88 are offset from each other in the above-described steering-force transmitting apparatus 12). Further, a position of the roller 180 engaged in the radially extending groove 190 is deviated or distant from the rotary axis of the input-side shaft 173 by a deviation distance that is equal to the above-described deviation distance L (by which the position of the roller 122 engaged in the radially extending groove 124 is deviated or distant from the rotation axis of the input-side shaft 88 in the above-described steering-force transmitting apparatus 12). That is, the steering-force transmitting apparatus 170 is configured to provide the vehicle operator with substantially the same operation feeling as the above-described steering-force transmitting apparatus 12.

As is apparent from FIG. 9, the steering-force transmitting apparatus 12 has an entire axial length that is smaller than that of the steering-force transmitting apparatus 170 as the comparative example. A difference ΔL between the entire axial lengths of the respective apparatuses 12, 170 substantially corresponds to a distance S by which the output shaft 18 is introduced in the lower shaft 60 (more precisely, by which the output shaft 18 is accommodated in the recess 114) in the apparatus 12. Further, although an outside diameter of the flange portion 64 of the lower shaft 60 of the apparatus 12 and an outside diameter of the flange portion 184 of the lower shaft 183 of the apparatus 170 are substantially equal to each other, the radial bearing 186 is fitted on an outer circumferential surface of the flange portion 184 in the apparatus 170 while no bearing is not fitted on an outer circumferential surface of the flange portion 64 in the apparatus 12. In the apparatus 12, the upper shaft 58 and the lower-shaft main body portion 62 as the main body portion of the main shaft 54 as the second shaft are supported by the column tube 56 via the radial bearings 76, 78, respectively, with no bearing on the outer circumferential surface of the flange portion 64. Therefore, a diameter R1 of an interconnecting portion of the apparatus 12 interconnecting the two shafts 60, 88 is smaller than a diameter R2 of an interconnecting portion of the apparatus 170 interconnecting the two shafts 173, 183. Thus, as compared with the apparatus 170 that provides substantially the same operation feeling as the apparatus 12, the apparatus 12 can be made compact in size as measured in the axial direction and also as measured in a direction perpendicular to the axial direction, so that its installability onto the vehicle is improved.

The reduction of the entire axial length of the apparatus makes it possible to increase an entire axial length of the column section 50 by an amount corresponding to the above-described difference ΔL, and accordingly to increase a stroke distance by which the column section 50 is extensible and contractible. Therefore, the present steering-force transmitting apparatus 12 can have an increased capacity of absorbing an impact caused in the event of a secondary collision between the vehicle operator and the steering wheel 10. Further, in the present apparatus 12, the radially protruding portion 118 of the input-side shaft 88 is distant from a rear end surface of the input-side shaft 88 and is located on a front side of the rear end surface of the input-side shaft 88, so that the radially protruding portion 118 of the flange portion 64 is located in a relatively front position and the stepped portion 74 of the lower tube 68 is located in a relatively front position. When the column section 50 is contracted, the contraction of the column section 50 is limited by contact of a front end of the upper tube 66 with the stepped portion 74 of the lower tube 68. Thus, in the present apparatus 12, also by disposing the radially protruding portion 118 of the input-side shaft 88 in a position distant from the rear end surface of the input-side shaft 88, it is possible to increase the stroke distance by which the column section 50 is extensible and contractible, and to absorb an impact caused by a secondary collision between the vehicle operator and the steering operation member. It is noted that, in the present apparatus 12, the radially protruding portion 118 is distant from the rear end surface of the input-side shaft 88 by a predetermined axial distance that is at least one-third as large as an outside diameter of a portion of the input-side shaft main body portion 120 from which the radially protruding portion 118 protrudes, so that the stroke distance of the column section 50 is made sufficiently large.

### <Modification of Embodiment>

For further improving the installability of the steering-force transmitting apparatus onto a vehicle, the outside diameter of the flange portion 64 of the lower shaft 60 can be reduced. However, the reduction of the outside diameter of the flange portion 64 could cause a risk that the engaging portion 122 (that is engaged in the radially extending groove 116 provided in the flange portion 64) protrudes outwardly from the outer circumferential surface of the flange portion 64 during operative rotation of the steering wheel 10. Therefore, for avoiding such a risk, it is necessary to reduce a distance by which the radially protruding portion 118 radially protrudes from the input-side shaft main body portion 120, namely, the above-described deviation distance L (see FIG. 4) by which a position of the engaging portion 122 engaged in the radially extending groove 116 is deviated or distant from the rotation axis of the input-side shaft 88. However, the above-described operation feeling provided to the vehicle operator who operates the steering wheel 10 varies depending on the deviation distance L by which the position of the engaging portion 122 is distant from the rotation axis of the input-side shaft 88. For obtaining substantially the same operation feeling, it is necessary to change also the above-described predetermined offset distance d (see FIG. 4) by which the axes of the respective input-side shaft 88 and lower shaft 60 are offset from each other. Further, it is also necessary to enable the engaging portion 116 to be moved within the radially extending groove 116 over a certain distance.

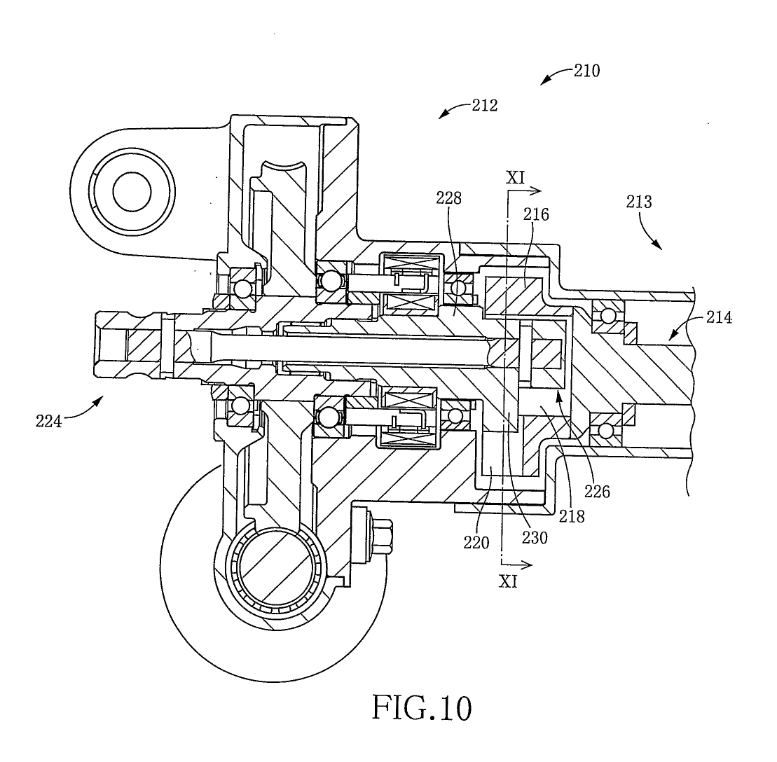

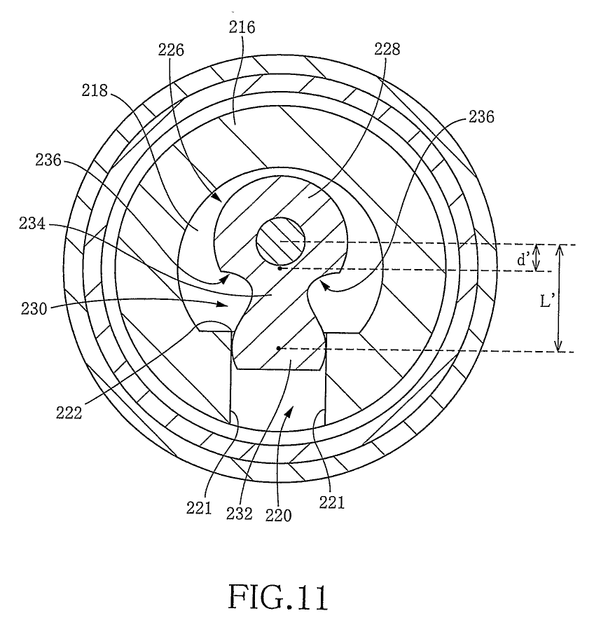

FIGS. 10-12 show a steering-force transmitting apparatus 210 as a modification of the embodiment, which is constructed in view of the above necessities. FIG. 10 is a cross sectional view showing an EPS section 212 provided in the steering-force transmitting apparatus 210. FIG. 11 is a cross sectional view taken along line XI-XI of FIG. 10. It is noted that a column section 213 provided in this apparatus 210 is not entirely shown in drawings since it is substantially the same in construction as the column section 50 provided in the above-described apparatus 12. It is further noted that, in the following description as to the apparatus 210, the same reference signs as used in the above-described apparatus 12 will be used to identify the functionally corresponding elements, and redundant description of these elements is not provided.

In the present steering-force transmitting apparatus 210, a lower shaft 214 has a radially projecting portion in the form of a circular-shaped flange portion 216 that is provided on a front end portion of the lower shaft 214. The flange portion 216 has an outside diameter that is smaller than the outside diameter of the flange portion 64 of the lower shaft 60 of the above-described steering-force transmitting apparatus 12. The lower shaft 214 further has a recess 218 that opens in a surface of a front end of the flange portion 216. A radially extending groove 220 is provided in the front end surface of the flange portion 216, so as to extend from the recess 218 in a radial direction of the lower shaft 214, such that the recess 218 is connected at its connected portion to the groove 220. The radially extending groove 220 is defined by a pair of side wall surfaces 221 which are parallel to each other and which extend in the radial direction. A radially inner end portion 222 of each of the side wall surfaces 221 protrudes radially inwardly toward the rotary axis of the lower shaft 214 so that a pair of radially inwardly convex portions are provided on the inner circumferential surface of the flange portion 216 (see FIG. 11).

The steering-force transmitting apparatus 210 includes an input-side shaft 226 that constitutes a part of an output shaft 224. The input-side shaft 226 includes an input-side shaft main body portion 228 and a radially protruding portion 230. The input-side shaft main body portion 228 extends in the axial direction, while the radially protruding portion 230 protrudes from the radially protruding portion 230 in the radial direction. A rear end portion of the input-side shaft main body portion 228 is accommodated in the recess 218, while the radially protruding portion 230 is introduced in the radially extending groove 220 via the connected portion of the recess 218 at which the recess 218 is connected to the groove 220. The radially protruding portion 230 includes a radially distal end portion serving as an engaging portion 232 that is engaged in the radially extending groove 220. The radially protruding portion 230 further includes a small-width portion 234 that is located between a radially proximal end portion of the radially protruding portion 230 and the engaging portion 232. The small-width portion 234 has a width smaller than a width of the engaging portion 232, as measured in the circumferential direction. The input-side shaft main body portion 228 has a contiguous portion which is contiguous to the radially proximal end of the radially protruding portion 230 and which is provided by two recessed portions 236 of an outer circumferential surface of the shaft main body portion 228.

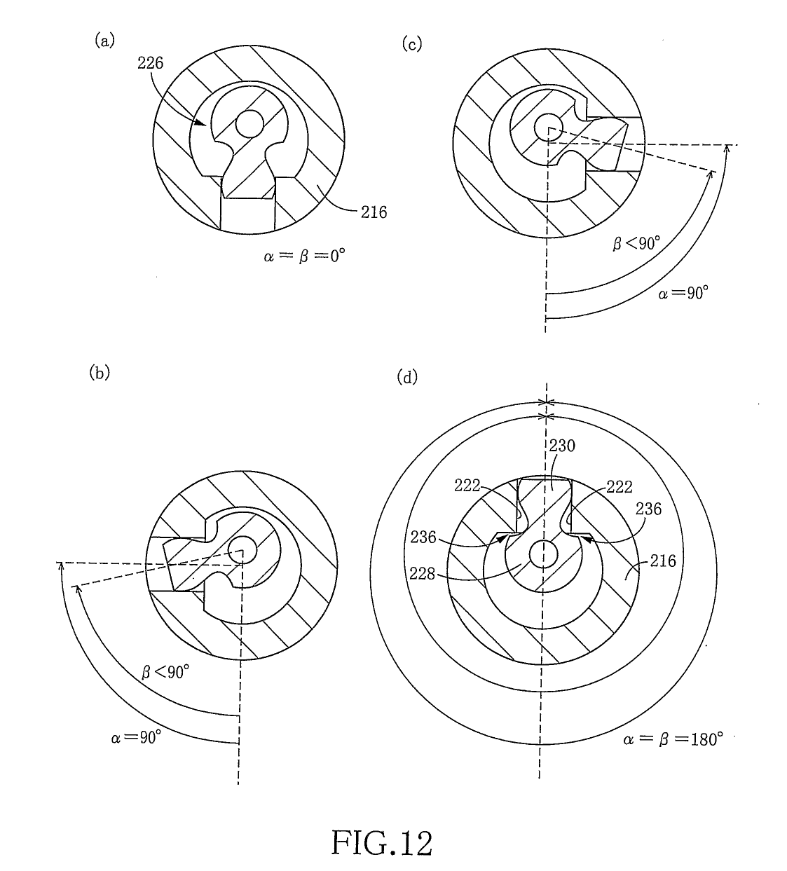

In the steering-force transmitting apparatus 210 constructed as described above, when the lower shaft 214 is rotated about its axis, a rotational force is transmitted from the lower shaft 214 to the input-side shaft main body portion 228 of the input-side shaft 226 via the radially protruding portion 230 that is introduced in the radially extending groove 220, whereby the input-side shaft 226 is rotated about its axis. FIG. 12 is a set of cross sectional views (a)-(d) taken along line XI-XI of FIG. 10 and showing the circular-shaped flange portion 216 of the lower shaft 214 and the input-side shaft 226 connected to the flange portion 216. The view (a) of FIG. 12 shows a stage in which the steering wheel 10 is positioned in its neutral operating position that causes the wheels to be held without turning. The view (b) of FIG. 12 shows a stage in which the steering wheel 10 has been operatively rotated by 90° in counterclockwise direction from the neutral operating position. The view (c) of FIG. 12 shows a stage in which the steering wheel 10 has been operatively rotated by 90° in clockwise direction from the neutral operating position. The view (d) of FIG. 12 shows a stage in which the steering wheel 10 has been operatively rotated by 180° in clockwise or counterclockwise direction from the neutral operating position.

As is understood from the views (a)-(d) of FIG. 12, when the rotational angle α of the lower shaft 214 and the rotational angle β of the input-side shaft 226 are 0° or 180°, each of the rotational phases of the respective two shafts 214, 226 is one of two predetermined values which cause the rotational phases of the respective two shafts 214, 226 to coincide with each other, so that the rotational phase difference becomes zero. During change of the rotational angle α of the lower shaft 214 or the rotational angle β of the input-side shaft 226 from 0° to 180°, the rotational phase difference is gradually increased until the rotational angle α of the lower shaft 214 or the rotational angle β of the input-side shaft 226 becomes a certain value, and is then gradually reduced after the rotational angle a of the lower shaft 214 or the rotational angle β of the input-side shaft 226 becomes the certain value. That is, in the present steering-force transmitting apparatus 210, as in the above-described steering-force transmitting apparatus 12, the gear ratio between the lower shaft 214 and the input-side shaft 226 is changed such that a moderate and stable steering performance is obtained in a stage in which an operating angle of the steering wheel 10 is small, and then a highly responsive steering performance is obtained in a stage in which the operating angle of the steering wheel 10 is large.

In FIG. 11, reference sign d′ represents an offset distance by which the axes of the respective input-side shaft 226 and lower shaft 214 are offset from each other, while reference sign L′ represents a deviation distance by which a position of the engaging portion 232 engaged in the radially extending groove 220 is deviated or distant from the rotation axis of the input-side shaft 226. In the present steering-force transmitting apparatus 210, a ratio e′ of the offset distance d′ to the deviation distance L′ is adapted to be equal to the above-described ratio e of the predetermined offset distance d (by which the axes of the respective input-side shaft 88 and lower shaft 60 are offset from each other, as shown in FIG. 4) to the deviation distance L (by which the position of the engaging portion 122 engaged in the radially extending groove 116 is deviated or distant from the rotation axis of the input-side shaft 88, as shown in FIG. 4), so that the apparatus 210 is configured to provide the vehicle operator with substantially the same operation feeling as the above-described apparatus 12.

Further, in the present steering-force transmitting apparatus 210, the radially inner end portion 222 of each of the side wall surfaces 221 protrudes radially inwardly toward the rotary axis of the lower shaft 214, as described above. When the steering wheel 10 has been operatively rotated by 180° in clockwise or counterclockwise direction from the neutral operating position, the radially inner end portion 222 of each of the side wall surfaces 221 is closer to the rotary axis of the input-side shaft 226 than to an outer periphery of the input-side shaft main body portion 228, as shown in view (d) of FIG. 12. Since the contiguous portion of the input-side shaft main body portion 228, which is contiguous to the radially proximal end of the radially protruding portion 230, is provided by the above-described recessed portions 236 of the outer circumferential surface of the shaft main body portion 228, the steering wheel 10 can be rotated without interference of the shaft main body portion 228 with the radially inner end portion 222 of each of the side wall surfaces 221.

1. A steering-force transmitting apparatus for a vehicle having (i) a steering operation member operable by an operator of the vehicle and (ii) a wheel turning device configured to turn a wheel of the vehicle, said steering-force transmitting apparatus comprising:
(a) an operating-member-side shaft connected at one of axially opposite end portions thereof to the steering operation member, and rotatable about an axis thereof;
(b) a turning-device-side shaft connected at one of axially opposite end portions thereof to the wheel tuning device, and rotatable about an axis thereof which is parallel to said axis of said operating-member-side shaft and which is offset from said axis of said operating-member-side shaft by a predetermined offset distance; and
(c) a rotation transmitting mechanism including:
(c-1) an engaging portion which is provided in a first shaft as one of said operating-member-side shaft and said turning-device-side shaft, and which is provided on a first main body portion that is a main body portion of said first shaft, so as to be rotatable together with said first main body portion, said engaging portion being held in engagement with the other of said axially opposite end portions of a second shaft as the other of said operating-member-side shaft and said turning-device-side shaft, said engaging portion being located in a non-central position that is distant from said axis of said first shaft in a radial direction of said first shaft by a distance larger than said predetermined offset distance; and
(c-2) a guide passage which is provided in said other of said axially opposite end portions of said second shaft and which is held in engagement with said engaging portion, said guide passage extending in a radial direction of said second shaft so as to allow displacement of said engaging portion in said radial direction of said second shaft,
wherein said rotation transmitting mechanism is configured to change a rotational phase difference between a rotational phase of said first shaft and a rotational phase of said second shaft, while causing one of said first and second shafts to be rotated by rotation of the other of said first and second shafts,
wherein said second shaft has axially opposite ends such that one of said axially opposite ends of said second shaft is a first-shaft side end of said second shaft that is closer to said first shaft than the other of said axially opposite ends of said second shaft,
wherein said first main body portion has axially opposite ends such that one of said axially opposite ends of said first main body portion is a second-shaft side end of said first main body portion that is closer to said second shaft than the other of said axially opposite ends of said first main body portion,
wherein said second-shaft side end of said first main body portion is located between said first-shaft side end of said second shaft and said one of said axially opposite end portions of said second shaft in an axial direction that is parallel to said axis of said first shaft and said axis of said second shaft, and
wherein said engaging portion is included in a radially protruding portion of said first shaft which protrudes outwardly from said first main body portion.

2. The steering-force transmitting apparatus according to claim 1,
wherein said guide passage is defined by a pair of side wall surfaces which extend in said radial direction of said second shaft and which are opposed to each other, and
wherein said engaging portion held in engagement with said guide passage is interposed between said side wall surfaces, so as to limit displacement of said engaging portion in a circumferential direction of said second shaft.

3. The steering-force transmitting apparatus according to claim 1,
wherein said first main body portion is a hollow portion having a space extending along said axis of said first shaft, and has axially opposite end portions such that one of said axially opposite end portions of said first main body portion is a second-shaft side end portion of said first main body portion that is closer to said second shaft than the other of said axially opposite end portions of said first main body portion,
wherein said first shaft has a torsion bar disposed in said space, and having axially opposite end portions such that one of said axially opposite end portions of said torsion bar is closer to said second shaft than the other of said axially opposite end portions of said torsion bar,
wherein said one of said axially opposite end portions of said torsion bar is unrotatably held by said second-shaft side end portion of said first main body portion such that said torsion bar is twistable by a rotational force that is applied to said first shaft, and
said steering-force transmitting apparatus further comprising:
an assisting device configured to generate, based on an amount of twisting deformation of said torsion bar, an assisting force that assists the wheel to be turned.

4. The steering-force transmitting apparatus according to claim 3, wherein said first shaft is said turning-device-side shaft while said second shaft is said operating-member-side shaft.

5. The steering-force transmitting apparatus according to claim 1,
wherein said second shaft includes:
a second main body portion which is a main body portion of said second shaft and which has axially opposite end portions such that one of said axially opposite end portions of said second main body portion is a first-shaft side end portion of said second main body portion that is closer to said first shaft than the other of said axially opposite end portions of said second main body portion; and
a radially projecting portion which is provided in said first-shaft side end portion of said second main body portion, and which projects outwardly from said second main body portion in said radial direction of said second shaft,
wherein said radially projecting portion has an axial end surface that constitutes a surface of said first-shaft side end of said second shaft, and
wherein said guide passage is provided in said radially projecting portion.

6. The steering-force transmitting apparatus according to claim 5, further comprising a tubular-shaped housing that is fixed to a part of a body of the vehicle,
wherein said second shaft is rotatably supported, at said second main body portion, by said housing.

7. The steering-force transmitting apparatus according to claim 5,
wherein said second shaft has a recess that opens in said axial end surface of said radially projecting portion,
wherein said first main body portion has axially opposite end portions such that one of said axially opposite end portions of said first main body portion is a second-shaft side end portion of said first main body portion that is closer to said second shaft than the other of said axially opposite end portions of said first main body portion, and
wherein said one of axially opposite end portions of said first main body portion is accommodated in said recess of said second shaft.

8. The steering-force transmitting apparatus according to claim 7,
wherein said guide passage has a proximal end as one of radially opposite ends thereof which is closer to said axis of said second shaft than the other of said radially opposite ends,
wherein said recess has a connected portion at which said recess is connected to said proximal end of said guide passage,
wherein said radially protruding portion protrudes outwardly from said one of said axially opposite end portions of said first main body portion, in a radial direction of said first shaft, such that said radially protruding portion is introduced into said guide passage via said connected portion of said recess, and
wherein said radially protruding portion has a radially distal end portion that serves as said engaging portion.

9. The steering-force transmitting apparatus according to claim 8,
wherein said guide passage is defined by a pair of side wall surfaces which extend in said radial direction of said second shaft and which are opposed to each other,
wherein said engaging portion held in engagement with said guide passage is interposed between said side wall surfaces, whereby displacement of said engaging portion in a circumferential direction of said second shaft is limited,
wherein said radially protruding portion has a small-width portion that is located between said radially distal end portion and a radially proximal end of said radially protruding portion, and
wherein a width of said small-width portion is made smaller than a width of said radially distal end portion, as measured in a circumferential direction of said first shaft, for thereby avoiding interference of said radially protruding portion with a radially inner end portion of each of said side wall surfaces, in spite of change of said rotational phase difference, said change causing change of an angle between said radial direction of said first shaft and said radial direction of said second shaft.

10. The steering-force transmitting apparatus according to claim 9,
wherein said rotation transmitting mechanism is configured to equalize said rotational phase of said first shaft and said rotational phase of said second shaft to each other, when said rotational phase of said first shaft is either one of two predetermined values,
wherein said radially inner end portion of each of said side wall surfaces is closer to said axis of said first shaft than to an outer periphery of said first main body portion when said rotational phase of said first shaft is one of the two predetermined values, and
wherein said first main body portion has a contiguous portion which is contiguous to said radially proximal end of said radially protruding portion and which is provided by at least one recessed portion of an outer circumferential surface of said first main body portion, said at least one recessed portion being recessed for avoiding interference of said first main body portion with said radially inner end portion of each of said side wall surfaces when said rotational phase of said first shaft is said one of the two predetermined values.

11. The steering-force transmitting apparatus according to claim 7,
wherein said guide passage is defined by a pair of side wall surfaces which extend in said radial direction of said second shaft and which are opposed to each other,
wherein said engaging portion, which is held in engagement with said guide passage, is interposed between said side wall surfaces, so as to limit displacement of said engaging portion in a circumferential direction of said second shaft,
wherein said engaging portion, which is interposed between said side wall surfaces and which is provided by said radially distal end portion of said radially protruding portion, is held in contact at contact surfaces thereof with said side wall surfaces, and
wherein said contact surfaces of said engaging portion cooperate with each other to define a cylindrical surface, for thereby avoiding separation of each of said contact surfaces from a corresponding one of said side wall surfaces, in spite of change of said rotational phase difference, said change causing change of an angle between said radial direction of said first shaft and said radial direction of said second shaft.

12. The steering-force transmitting apparatus according to claim 8,
wherein said first shaft is said turning-device-side shaft while said second shaft is said operating-member-side shaft, and
wherein said radially protruding portion, which protrudes from said second-shaft side end portion of said first main body portion, is located in an axially shifted position that is shifted from said second-shaft side end of said first main body portion, in a direction which is away from said second shaft and which is parallel to an axial direction parallel to said axis of said first shaft and said axis of said second shaft.

13. The steering-force transmitting apparatus according to claim 12,
wherein said radially protruding portion has axially opposite ends such that one of said axially opposite ends of said radially protruding portion is closer to said second shaft than the other of said axially opposite ends of said radially protruding portion,
wherein said one of said axially opposite ends of said radially protruding portion is distant from said one of said axially opposite ends of said first main body portion by a predetermined axial distance as measured in said axial direction, and
wherein said predetermined axial distance is at least one-third as large as an outside diameter of said one of said axially opposite end portions of said first main body portion from which said radially protruding portion protrudes.

14. The steering-force transmitting apparatus according to claim 12, further comprising a tubular-shaped housing that is fixed to a part of a body of the vehicle,
wherein said second shaft is rotatably supported, at said second main body portion, by said housing,
wherein said second main body portion is extensible and contractible in directions parallel to said axis of said second shaft,
wherein said tubular-shaped housing includes:
a first tubular member; and
a second tubular member having a small diameter portion, a large diameter portion and a stepped portion that interconnects said large and small diameter portions, said small diameter portion having an outside diameter smaller than an inside diameter of said first tubular member, said large diameter portion having an outside diameter larger than said inside diameter of said first tubular member,
wherein said small diameter portion of said second tubular member is introduced into said first tubular member from an axial end portion of said first tubular member, so as to be fitted in said first tubular member, such that said first and second tubular members are slidingly movable relative to each other whereby said tubular-shaped housing is extensible and contractible, and such that contraction of said tubular-shaped housing is limited upon contact of said axial end portion of said first tubular member with said stepped portion of said second tubular member,
wherein said second main body portion is rotatably supported by cooperation of said first tubular member and said small diameter portion of said second tubular member, while said radially projecting portion is accommodated in said large diameter portion of said second tubular member.
